(19) United States
(12) Patent Application Publication
(10) Pub. No.: US 2025/0070935 A1
(43) Pub. Date: Feb. 27, 2025

(54) SYSTEM AND METHOD FOR PROVIDING ADDITIONAL DM-RS PORTS FOR 5G MU-MIMO TRANSMISSION

(71) Applicant: Huawei Technologies Co., Ltd., Shenzhen (CN)

(72) Inventors: Qian Cheng, Naperville, IL (US); Weimin Xiao, Hoffman Estates, IL (US); Jialing Liu, Palatine, IL (US); Zhigang Rong, San Diego, CA (US)

(21) Appl. No.: 18/916,113

(22) Filed: Oct. 15, 2024

Related U.S. Application Data
(63) Continuation of application No. PCT/US2023/017608, filed on Apr. 5, 2023.
(60) Provisional application No. 63/335,590, filed on Apr. 27, 2022.
(60) Provisional application No. 63/335,606, filed on Apr. 27, 2022.

(51) Int. Cl. H04L 5/00; H04B 7/0452

(52) U.S. Cl. CPC H04L 5/0048; H04B 7/0452

(57) ABSTRACT

A user equipment (UE) may receive, from a base station, a configuration indicating a first orthogonal cover code (OCC) length that is 4 and a second OCC length that is 2 for demodulation reference signals (DM-RSs) communications between the base station and the UE. The UE may receive a signaling indicating the UE to communicate DM-RS(s) according to the first OCC length or the second OCC length. The UE may communicate, with the base station, a DM-RS according to the first OCC length or the second OCC length indicated by the signaling.

### CROSS-REFERENCE TO RELATED APPLICATIONS

This patent application is a continuation of International Patent Application No. PCT/US2023/017608 filed on Apr. 5, 2023, and entitled “SYSTEM AND METHOD FOR PROVIDING ADDITIONAL DM-RS PORTS FOR 5G MU-MIMO TRANSMISSION,” which claims priority to U.S. Provisional Application No. 63/335,590, filed on Apr. 27, 2022 and entitled “SYSTEM AND METHOD FOR ADDING ADDITIONAL DM-RS PORTS FOR 5G MU-MIMO TRANSMISSION,” and U.S. Provisional Application No. 63/335,606, filed on Apr. 27, 2022 and entitled “SYSTEM AND METHOD FOR ADDING ADDITIONAL DM-RS PORTS FOR 5G MU-MIMO TRANSMISSION,” which are hereby incorporated by reference herein as if reproduced in their entireties.

### TECHNICAL FIELD

The present disclosure relates generally to telecommunications, and, in particular embodiments, to a system and method for providing additional DM-RS ports for 5G MU-MIMO transmission.

### BACKGROUND

Downlink and uplink transmissions in 5G new radio (NR) are based on demodulation reference signals (DM-RSs). In single user/multi user multi input multi output (SU/MU-MIMO) transmissions, each DM-RS port may carry DM-RS(s) used for channel estimation for demodulation of the corresponding data layer transmitted on the same port. It is desirable to have a large number of orthogonal DM-RS ports and multiplexing scheme(s) with relatively small DM-RS overhead, while ensuring good demodulation performance to support a large number of data layers for massive SU/MU-MIMO transmissions.

### SUMMARY

According to one aspect of the present disclosure, a method is provided that includes: receiving, by a user equipment (UE) from a gNB, a configuration configuring a first orthogonal cover code (OCC) length that is 4 and a second OCC length that is 2 for demodulation reference signal (DM-RS) communication between the gNB and the UE; receiving, by the UE, a signaling indicating the UE to communicate DM-RS(s) according to the first OCC length or the second OCC length; and communicating, by the UE with the gNB, a DM-RS according to the first OCC length or the second OCC length that is indicated by the signaling.

Optionally, in any of the preceding aspects, the signaling is a RRC signaling.

Optionally, in any of the preceding aspects, the signaling is carried in a medium access control (MAC) control element (CE).

Optionally, in any of the preceding aspects, the signaling is carried in a downlink control information (DCI) message.

Optionally, in any of the preceding aspects, the method further includes: sending, by the UE to the gNB, a message acknowledging receipt of the configuration.

Optionally, in any of the preceding aspects, communicating the DM-RS comprises: receiving or sending, by the UE, the DM-RS over DM-RS port(s) associated with OCC(s) of the first OCC length when the first OCC length is indicated by the signaling, or over DM-RS port(s) associated with OCC(s) of the second OCC length when the second OCC length is indicated by the signaling.

Optionally, in any of the preceding aspects, the method further includes: receiving, by the UE, a physical downlink shared channel (PDSCH) over the DM-RS port(s) associated with the OCC(s) of the first OCC length or over the DM-RS port(s) associated with OCC(s) of the second OCC length; or transmitting, by the UE, a physical uplink shared channel (PUSCH) over the DM-RS port(s) associated with the OCC(s) of the first OCC length or over the DM-RS port(s) associated with OCC(s) of the second OCC length.

Optionally, in any of the preceding aspects, an OCC of the first OCC length comprises: [+1+1+1+1], [+1−1+1−1], [+1+j−1−j], or [+1−j−1+j].

Optionally, in any of the preceding aspects, the method further includes: receiving, by the UE, a DCI message comprising an indication; and receiving, by the UE, a DM-RS port offset bit, the indication and the DM-RS port offset bit in combination indicating information of DM-RS port(s) to be used by the UE.

Optionally, in any of the preceding aspects, the method further includes: when the first OCC length is indicated by the signaling and the DM-RS port offset bit has a first value, determining, by the UE, that the DM-RS port(s) to be used have first port number(s) corresponding to the indication according to a first correspondence associated with the second OCC length; or when the first OCC length is indicated by the signaling and the DM-RS port offset bit has a second value, determining, by the UE, that the DM-RS port(s) to be used have second port number(s) obtained by adding a non-zero integer and the first port number(s), respectively.

Optionally, in any of the preceding aspects, the non-zero integer is 8 or 12.

Optionally, in any of the preceding aspects, the method further includes: when the first OCC length is indicated by the signaling and the DM-RS port offset bit has a first value, determining, by the UE, that the DM-RS port(s) to be used have port number(s) according to a first correspondence between the port number(s) and the indication, the first correspondence associated with the second OCC length; or when the first OCC length is indicated by the signaling and the DM-RS port offset bit has a second value, determining, by the UE, that the DM-RS port(s) to be used have port number(s) according to a second correspondence between the port number(s) and the indication, the second correspondence associated with the first OCC length.

Optionally, in any of the preceding aspects, the DM-RS port offset bit is comprised in the DCI message.

Optionally, in any of the preceding aspects, the DCI message is a legacy DCI message.

Optionally, in any of the preceding aspects, a number of DM-RS ports associated with the first OCC length of 4 is: 8 when one symbol is configured for type-1 DM-RS transmissions, 16 when 2 symbols are configured for type-1 DM-RS transmissions, 12 when one symbol is configured for type-2 DM-RS transmissions, or 24 when two symbols are configured for type-2 DM-RS transmissions.

Optionally, in any of the preceding aspects, the communications of DM-RSs comprise type-1 DM-RS transmissions or type-2 DM-RS transmissions.

According to another aspect of the present disclosure, a method is provided that includes: transmitting, by a communication device, a first demodulation reference signal (DM-RS) over first DM-RS port(s) associated with a orthogonal cover code (OCC) of length 4; or receiving, by the communication device, a second DM-RS over second DM-RS port(s) associated with an OCC of length 4.

Optionally, in any of the preceding aspects, the communication device is a user equipment (UE) or a gNB.

Optionally, in any of the preceding aspects, the OCC comprises: [+1+1+1+1], [+1−1+1−1], [+1+j−1−j], or [+1−j−1+j].

Optionally, in any of the preceding aspects, the method further includes: receiving, by the communication device being a user equipment (UE), a DCI message comprising an indication; and receiving, by the UE, a DM-RS port offset bit, the indication and the DM-RS port offset bit in combination indicating information of the DM-RS port(s).

Optionally, in any of the preceding aspects, the method further includes: when the DM-RS port offset bit has a first value, determining, by the UE, that the DM-RS port(s) have first port number(s) corresponding to the indication according to a first correspondence associated with an OCC having a length of 2; or when the DM-RS port offset bit has a second value, determining, by the UE, that the DM-RS port(s) have second port number(s) obtained by adding a non-zero integer and the first port number(s), respectively.

Optionally, in any of the preceding aspects, the non-zero integer is 8 or 12.

Optionally, in any of the preceding aspects, the method further includes: when the DM-RS port offset bit has a first value, determining, by the UE, the DM-RS port(s) according to a first correspondence between the port number(s) and the indication, the first correspondence associated with an OCC having a length of 2; or when the DM-RS port offset bit has a second value, determining, by the UE, the DM-RS port(s) according to a second correspondence between the port number(s) and the indication, the second correspondence associated with the OCC having the length of 4.

Optionally, in any of the preceding aspects, the method further includes: sending, by the communication device being a gNB, a DCI message comprising an indication; and sending, by the gNB, a DM-RS port offset bit, the indication and the DM-RS port offset bit in combination indicating the DM-RS port(s).

Optionally, in any of the preceding aspects, the DM-RS port offset bit is comprised in the DCI message.

Optionally, in any of the preceding aspects, the DCI message is a legacy DCI message.

Optionally, in any of the preceding aspects, a number of DM-RS ports associated with the OCC having the length of 4 is: 8 when one symbol is configured for Type-1 DM-RS transmissions, 16 when two symbols are configured for Type-1 DM-RS transmissions, 12 when one symbol is configured for Type-2 DM-RS transmissions, or 24 when two symbols are configured for Type-2 DM-RS transmissions.

Optionally, in any of the preceding aspects, the first DM-RS or the second DM-RS comprises a Type-1 DM-RS or a Type-2 DM-RS.

According to another aspect of the present disclosure, a method is provided that includes: sending, by a gNB to a user equipment (UE), a configuration configuring a first orthogonal cover code (OCC) length that is 4 and a second OCC length that is 2 for demodulation reference signal (DM-RS) communication between the gNB and the UE; sending, by the gNB, a signaling indicating the UE to communicate DM-RS(s) according to the first OCC length or the second OCC length; and communicating, by the gNB with the UE, a DM-RS according to the first OCC length or the second OCC length that is indicated by the signaling.

Optionally, in any of the preceding aspects, sending the configuration comprises: sending, by the gNB, the configuration in a radio resource control (RRC) signaling.

Optionally, in any of the preceding aspects, the signaling is a RRC signaling.

Optionally, in any of the preceding aspects, the signaling is carried in a medium access control (MAC) control element (CE).

Optionally, in any of the preceding aspects, the signaling is carried in a downlink control information (DCI) message.

Optionally, in any of the preceding aspects, the method further includes: receiving, by the gNB from the UE, a message acknowledging receipt of the configuration.

Optionally, in any of the preceding aspects, communicating the DM-RS comprises: receiving or sending, by the gNB, the DM-RS over DM-RS port(s) associated with OCC(s) of the first OCC length when the first OCC length is indicated by the signaling, or over DM-RS port(s) associated with OCC(s) of the second OCC length when the second OCC length is indicated by the signaling.

Optionally, in any of the preceding aspects, the method further includes: sending, by the gNB, a physical downlink shared channel (PDSCH) over the DM-RS port(s) associated with the OCC(s) of the first OCC length or over the DM-RS port(s) associated with OCC(s) of the second OCC length; or receiving, by the gNB, a physical uplink shared channel (PUSCH) over the DM-RS port(s) associated with the OCC(s) of the first OCC length or over the DM-RS port(s) associated with OCC(s) of the second OCC length.

Optionally, in any of the preceding aspects, an OCC of the first OCC length comprises: [+1+1+1+1], [+1−1+1−1], [+1+j−1−j], or [+1−j−1+j].

Optionally, in any of the preceding aspects, the method further includes: sending, by the gNB, a DCI message comprising an indication; and sending, by the gNB, a DM-RS port offset bit, the indication and the DM-RS port offset bit in combination indicating DM-RS port(s) to be used.

Optionally, in any of the preceding aspects, when the first OCC length is indicated by the signaling and the DM-RS port offset bit has a first value, the DM-RS port(s) to be used have first port number(s) corresponding to the indication according to a first correspondence associated with the second OCC length; or when the first OCC length is indicated by the signaling and the DM-RS port offset bit has a second value, the DM-RS port(s) to be used have second port number(s) obtained by adding a non-zero integer and the first port number(s), respectively.

Optionally, in any of the preceding aspects, the non-zero integer is 8 or 12.

Optionally, in any of the preceding aspects, when the first OCC length is indicated by the signaling and the DM-RS port offset bit has a first value, the DM-RS port(s) to be used have port number(s) according to a first correspondence between the port number(s) and the indication, the first correspondence associated with the second OCC length; or when the first OCC length is indicated by the signaling and the DM-RS port offset bit has a second value, the DM-RS port(s) to be used have the port number(s) according to a second correspondence between the port number(s) and the indication, the second correspondence associated with the first OCC length.

Optionally, in any of the preceding aspects, the DM-RS port offset bit is comprised in the DCI message.

Optionally, in any of the preceding aspects, the DCI message is a legacy DCI message.

Optionally, in any of the preceding aspects, a number of DM-RS ports associated with the first OCC length of 4 is: 8 when one symbol is configured for type-1 DM-RS transmissions, 16 when 2 symbols are configured for type-1 DM-RS transmissions, 12 when one symbol is configured for type-2 DM-RS transmissions, or 24 when two symbols are configured for type-2 DM-RS transmissions.

Optionally, in any of the preceding aspects, the communications of DM-RSs comprise Type-1 DM-RS transmissions or Type-2 DM-RS transmissions.

According to another aspect of the present disclosure, an apparatus is provided that includes a non-transitory memory storage comprising instructions, and one or more processors in communication with the memory storage, wherein the instructions, when executed by the one or more processors, cause the device to perform a method in any of the preceding aspects.

According to another aspect of the present disclosure, a non-transitory computer-readable media is provided, which stores computer instructions, that when executed by one or more processors, cause the one or more processors to perform a method in any of the preceding aspects.

According to another aspect of the present disclosure, a system is provided that includes a gNB and a user equipment (UE) in communication with the gNB; wherein the UE is configured to perform: receiving, from a gNB, a configuration configuring a first orthogonal cover code (OCC) length that is 4 and a second OCC length that is 2 for demodulation reference signal (DM-RS) communication between the gNB and the UE; receiving a signaling indicating the UE to communicate DM-RS(s) according to the first OCC length or the second OCC length; and communicating, with the gNB, a DM-RS according to the first OCC length or the second OCC length that is indicated by the signaling; and wherein the gNB is configured to perform: sending the configuration to the UE; sending the signaling to the UE; and communicating the DM-RS with the UE.

According to another aspect of the present disclosure, an apparatus is provided that includes: a receive module configured to receive, from a gNB, a configuration configuring a first orthogonal cover code (OCC) length that is 4 and a second OCC length that is 2 for demodulation reference signal (DM-RS) communication between the gNB and the UE, and receive a signaling indicating the UE to communicate DM-RS(s) according to the first OCC length or the second OCC length; and a communication module configured to communicate, with the gNB, a DM-RS according to the first OCC length or the second OCC length that is indicated by the signaling.

According to another aspect of the present disclosure, an apparatus is provided that includes: a transmit module configured to transmit a first demodulation reference signal (DM-RS) over first DM-RS port(s) associated with an orthogonal cover code (OCC) of length 4; or a receive module configured to receive a second DM-RS over second DM-RS port(s) associated with an OCC of length 4.

According to another aspect of the present disclosure, an apparatus is provided that includes: a transmit module configured to: transmit, to a user equipment (UE), a configuration configuring a first orthogonal cover code (OCC) length that is 4 and a second OCC length that is 2 for demodulation reference signal (DM-RS) communication between the gNB and the UE; and transmit a signaling indicating the UE to communicate DM-RS(s) according to the first OCC length or the second OCC length; and a communication module configured to communicate, with the UE, a DM-RS according to the first OCC length or the second OCC length that is indicated by the signaling.

The above aspects in the present disclosure enable communication of DM-RSs according to an OCC length 4. This increases the number of orthogonal DM-RS ports that can be used for DM-RS communication with relatively small DM-RS overhead, allows for good demodulation performance, and enables supporting a large number of data layers for massive SU/MU-MIMO transmissions. The above aspects in the present disclosure also enable fast switching between communication of DM-RSs according to an OCC length 4 and communication of DM-RSs according to an OCC length 2. This allows for dynamic switching between robust and high throughput SU/MU-MIMO transmissions according to a UE's channel environment and communication need.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagram of an embodiment communication network;

FIG. 2 is a diagram of example resource allocations for orthogonal DM-RS antenna ports according to a legacy Type-1 DM-RS configuration;

FIG. 3 is a diagram of another example resource allocations for orthogonal DM-RS antenna ports according to the legacy Type-1 DM-RS configuration;

FIG. 4 is a diagram of example resource allocations for orthogonal DM-RS antenna ports according to a legacy Type-2 DM-RS configuration;

FIG. 5 is a diagram of another example resource allocations for orthogonal DM-RS antenna ports according to the legacy Type-2 DM-RS configuration;

FIG. 6A and FIG. 6B show an embodiment configuration of doubling DM-RS ports for Type-1 DM-RS configuration with one OFDM symbol configured according to scheme 1;

FIG. 7A, FIG. 7B, FIG. 7C and FIG. 7D show an embodiment configuration of doubling DM-RS ports for the Type-1 DM-RS configuration with two OFDM symbols configured according to scheme 1;

FIG. 8 is a diagram showing embodiment relative timing locations of Type-1 DM-RS ports of FIGS. 6A-6B and FIGS. 7A-7D;

FIG. 9 is a diagram of an embodiment DM-RS port assignment for UEs in a cyclic shift and comb domain;

FIG. 10 is a diagram of an embodiment configuration of doubling DM-RS ports for the Type-1 DM-RS configuration with one OFDM symbol configured according to scheme 2;

FIG. 11A and FIG. 11B show an embodiment configuration of doubling DM-RS ports for the Type-1 DM-RS configuration with two OFDM symbols configured according to scheme 2;

FIG. 12 is a diagram showing embodiment relative timing locations of DM-RS ports of FIG. 10;

FIG. 13 is a diagram showing embodiment relative timing locations of DM-RS ports of FIGS. 11A-11B;

FIG. 14 is a diagram of another embodiment DM-RS ports assignment for UEs in the cyclic shift and comb domain;

FIG. 15 is a flowchart of an embodiment method, highlighting mode configuration and activation through RRC signaling;

FIG. 16 is a flowchart of an embodiment method, highlighting mode configuration through RRC signaling and mode activation through a MAC-CE;

FIG. 17 is a flowchart of an embodiment method, highlighting mode configuration through RRC signaling and mode activation through DCI;

FIG. 18 is a diagram of an embodiment configuration of doubling DM-RS ports of Type-2 DM-RS configuration with one OFDM symbol configured;

FIG. 19 is a diagram of an embodiment configuration of doubling DM-RS ports of the Type-2 DM-RS configuration with two OFDM symbols configured;

FIG. 20 is a diagram of embodiment relative subcarrier locations of DM-RS ports in FIG. 18 and FIG. 19;

FIG. 21 is a diagram of an embodiment DM-RS ports assignment in a frequency domain for UEs based on the Type-2 DM-RS configuration;

FIG. 22 is a flowchart of an embodiment method for DM-RS communication;

FIG. 23 is a flowchart of another embodiment method for DM-RS communication;

FIG. 24 is a flowchart of another embodiment method for DM-RS communication;

FIG. 25 is a block diagram of an embodiment processing system for performing methods described herein; and

FIG. 26 is a block diagram of an embodiment transceiver adapted to transmit and receive signaling over a telecommunications network.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF THE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

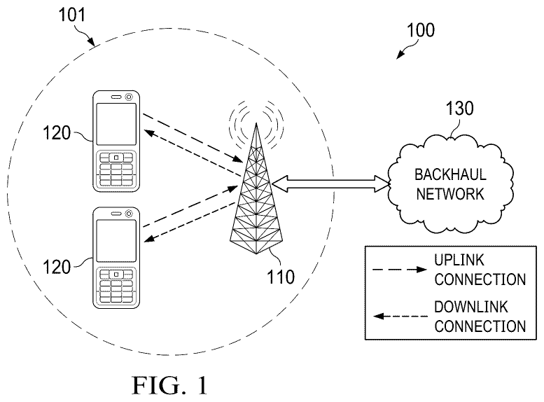

FIG. 1 illustrates a network 100 for communicating data. The network 100 comprises a base station 110 having a coverage area 101, a plurality of user equipments (UEs) 120, and a backhaul network 130. As shown, the base station 110 establishes uplink (dashed line) and/or downlink (dotted line) connections with the UEs 120, which serve to carry data from the UEs 120 to the base station 110 and vice-versa. Data carried over the uplink/downlink connections may include data communicated between the UEs 120, as well as data communicated to/from a remote-end (not shown) by way of the backhaul network 130. As used herein, the term “base station” refers to any component (or collection of components) configured to provide wireless access to a network, such as a Node B, an evolved Node B (eNB), a next generation (NG) Node B (gNB), a master eNB (MeNB), a secondary eNB (SeNB), a master gNB (MgNB), a secondary gNB (SgNB), a network controller, a control node, an access node (AN), an access point (AP), a transmission point (TP), a transmission-reception point (TRP), a cell, a carrier, a macro cell, a femtocell, a pico cell, a relay, a customer premises equipment (CPE), a WI-FI access point (AP), or other wirelessly enabled devices. Base stations may provide wireless access in accordance with one or more wireless communication protocols, e.g., long term evolution (LTE), LTE advanced (LTE-A), High Speed Packet Access (HSPA), WI-FI 802.11a/b/g/n/ac, etc. As used herein, the term “user equipment” refers to any component (or collection of components) capable of establishing a wireless connection with a base station. UEs may also be commonly referred to as mobile stations, mobile devices, mobiles, terminals, users, subscribers, stations, communication devices, CPEs, relays, Integrated Access and Backhaul (IAB) relays, and the like. It is noted that when relaying is used (based on relays, picos, CPEs, and so on), especially multi-hop relaying, the boundary between a controller and a node controlled by the controller may become blurry, and a dual node (e.g., either the controller or the node controlled by the controller) deployment where a first node that provides configuration or control information to a second node is considered to be the controller. Likewise, the concept of UL and DL transmissions can be extended as well. In some embodiments, the network 100 may include various other wireless devices, such as relays, low power nodes, etc.

Downlink and uplink transmissions, e.g., in 5G new radio (NR), are based on DM-RSs (demodulation reference signals). For example, in single user/multi user multi input multi output (SU/MU-MIMO) transmissions, each DM-RS port may carry a DM-RS, which will be used for channel estimation in order for demodulation of the corresponding data layer transmitted on the same port. The DM-RS design needs to consider different scenarios, and various and sometimes conflicting requirements. It is desirable to have a large number of orthogonal DM-RS ports and multiplexing scheme(s) with relatively small DM-RS overhead (e.g., frequency and/or time resources used for DM-RS transmission), while ensuring good demodulation performance to support the large number of data layers for massive SU/MU-MIMO transmissions.

For DM-RS time and frequency pattern in the grid of sub-carriers (in the frequency domain) and orthogonal frequency division multiplexing (OFDM) symbols (in the time domain), two types (i.e., Type-1 and Type-2) of DM-RS configurations are introduced in NR. Type-1 DM-RS configuration supports up to 4 orthogonal DM-RS ports when 1 OFDM symbol is configured for DM-RS transmission, and up to 8 orthogonal DM-RS ports when 2 OFDM symbols are configured for DM-RS transmission. Type-2 DM-RS configuration supports up to 6 orthogonal DM-RS ports when 1 OFDM symbol is configured for DM-RS transmission, and up to 12 orthogonal DM-RS ports when 2 OFDM symbols are configured for DM-RS transmission. The orthogonal DM-RS ports configured for DM-RS transmission are multiplexed in the time domain and the frequency domain using orthogonal cover codes (OCCs). Both types of DM-RS configurations are configurable for downlink and uplink transmissions. The Type-1/Type-2 of DM-RS configuration may be referred to as Type-1/Type-2 DM-RS configuration, or Type-1/Type-2 configuration, or DM-RS configuration Type 1/Type 2 (type 1/type 2) in the present disclosure. The Type-1 configuration for legacy UEs is referred to as legacy Type-1 DM-RS configuration or legacy Type-1 configuration. The Type-2 configuration for legacy UEs is referred to as legacy Type-2 DM-RS configuration or legacy Type-2 configuration. DM-RS configured according to the Type-1/Type-2 DM-RS configuration may be referred to as Type-1/Type-2 DM-RS.

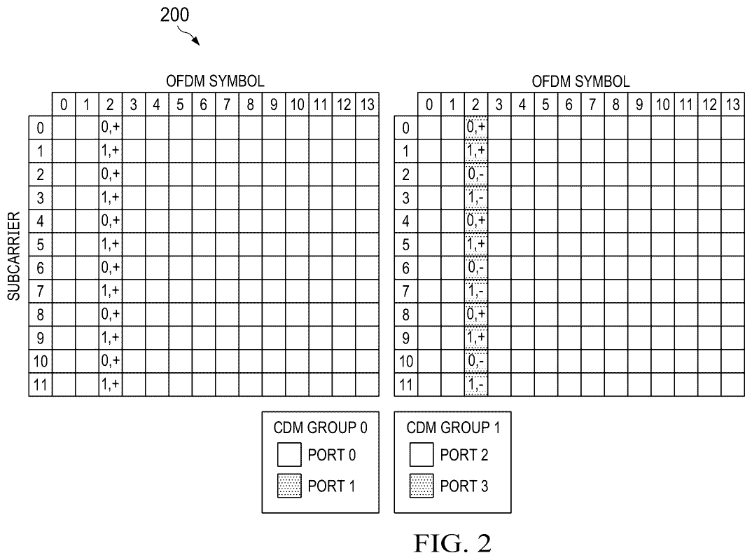

FIG. 2 is a diagram 200 showing example resource allocations in the grid of subcarrier and OFDM symbol (i.e., resource elements (REs)) for orthogonal DM-RS antenna ports according to the legacy Type-1 configuration when one symbol is configured. For the legacy Type-1 configuration, a comb of every other sub-carrier (or tone) in frequency and an OCC pattern in frequency are allocated to a DM-RS antenna port. With 2 combs and 2 OCC patterns, 4 orthogonal DM-RS ports are supported when 1 OFDM symbol (the symbol #2 in this example) is configured for DM-RS transmission. As shown in FIG. 2, according to the example legacy Type-1 configuration, two CDM groups (i.e., CDM group 0 and DCM group 1) are provided. CDM group 0 includes port 0 and port 1, and CDM group 1 includes port 2 and port 3. REs at the symbol #2 and subcarriers of even indexes are allocated for CDM group 0, and REs at the symbol #2 and subcarriers of odd indexes are allocated for CDM group 1. The four ports are multiplexed in the frequency domain using OCC patterns [+1+1] and [+1−1],which have an OCC length (or size) of 2. The OCC patterns [+1+1], [+1−1] may be referred to as legacy OCC patterns, or legacy patterns, or legacy OCC.

In embodiments of the present disclosure, a representation “n,s” shown on a RE (e.g., a box in FIG. 2) is used to indicate that the RE is allocated for a CDM group n and an OCC value s is applied to the RE. n is an integer greater than or equal to zero (0), and s may be +, −, +1, −1, +j, or −j. “+” and “+1” represent the same OCC value “+1”. “−” and “−1” represent the same OCC value “−1”. As an example, in FIG. 2, “0,+” shown on a RE at the symbol #2 and subcarrier index o indicates that this RE is for CDM group 0 and OCC value “+1” is applied to this RE in DM-RS transmission. As another example, “1,+” shown on a RE at the symbol #2 and subcarrier index 1 indicates that this RE is for CDM group 1 and OCC value “+1” is applied to this RE in DM-RS transmission. As another example, “1,−” shown on a RE at the symbol #2 and subcarrier index 7 indicates that this RE is for CDM group 1 and OCC value “−1” is applied to this RE in DM-RS transmission. This representation is used similarly in FIGS. 2-7, 10, 11, 18 and 19. DM-RS ports of the same CDM group are indicated with different shadings in these figures.

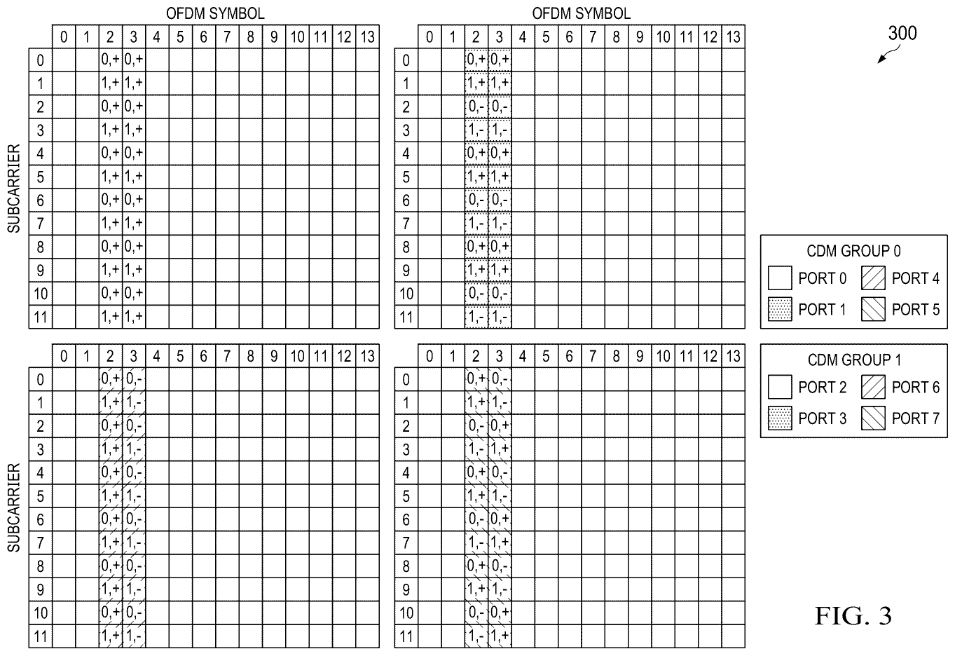

When two (2) OFDM symbols are configured for the legacy Type-1 configuration, a time domain OCC of length 2 may further be used to generate orthogonal DM-RS ports, which gives a total of 8 orthogonal ports, as shown in FIG. 3. FIG. 3 is a diagram 300 showing example resource allocations for orthogonal DM-RS antenna ports according to the legacy Type-1 configuration when two symbols are configured. In this example, two CDM groups are provided (i.e., CDM group 0 and CDM group 1), and each group includes four ports (ports 0, 1, 4, 5 in CDM group 0, and ports 2, 3, 6, 7 in CDM group 1). Each port occupies symbols #2 and #3. The Type-1 configuration can be configured for cyclic prefix (CP)-OFDM PDSCH and PUSCH transmission. For discrete Fourier transform-spread (DFT-S)-OFDM PUSCH, only Type-1 DM-RS is used.

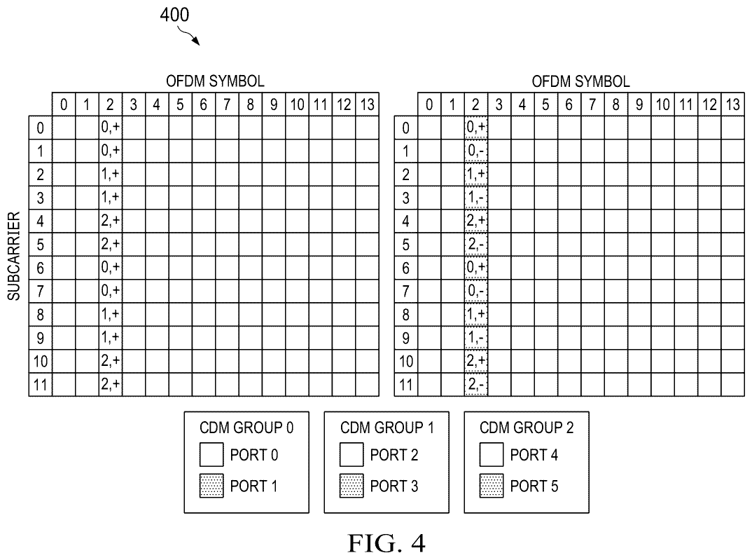

For DM-RS Type-2 configuration, a frequency domain OCC of length 2 over adjacent 2 REs and frequency division multiplexing (FDM) are used to support 6 orthogonal DM-RS ports when 1 OFDM symbol is configured for DM-RS transmission. FIG. 4 is a diagram 400 showing example resource allocations for the 6 ports according to the DM-RS Type-2 configuration when 1 OFDM symbol is configured. The 6 ports are included in three CDM groups, i.e., CDM group 0, CDM group 1, and CDM group 2. As an example, in FIG. 4, “0,+” shown on a RE at the symbol #2 and subcarrier index o indicates that this RE is for CDM group 0 and OCC value “+1” is applied to this RE in DM-RS transmission. As another example, “2,−” shown on a RE at the symbol #2 and subcarrier index 5 indicates that this RE is for CDM group 2 and OCC value “−1” is applied to this RE in DM-RS transmission.

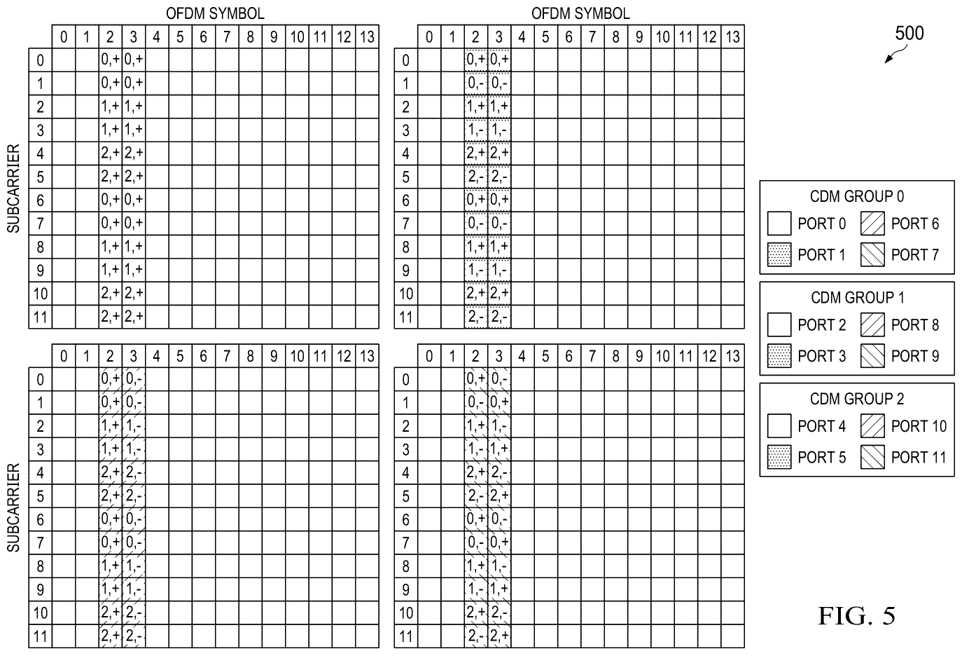

When 2 OFDM symbols are configured for DM-RS transmission, a time domain OCC of length 2 may further be used to generate orthogonal DM-RS ports according to the DM-RS Type-2 configuration, which gives a total of 12 orthogonal ports. FIG. 5 is a diagram 500 showing example resource allocations for the 12 ports according to the DM-RS Type-2 configuration. With more orthogonal ports, the Type-2 configuration can potentially provide high system throughput for massive MIMO where larger number of data streams of MU-MIMO is desired.

Two configurable 16-bit DM-RS scrambling IDs are supported for scrambling DM-RSs. Configuration of the DM-RS scrambling IDs may be made using RRC signaling. A DM-RS scrambling ID may also be dynamically selected and indicated by downlink control information (DCI). Before the utilization of the RRC configured 16-bit DM-RS scrambling IDs, a cell ID is used for DM-RS scrambling.

When mapping to symbol locations of a physical downlink shared channel/Physical uplink shared channel (PDSCH/PUSCH) transmission within a slot, front-loaded DM-RS symbol(s) (for front-loaded DM-RS) only or front-loaded DM-RS plus additional DM-RS symbol(s) (for front-loaded DM-RS and additional DM-RS) can be configured. The additional DM-RS, when present, may have the same configuration as that of the front-loaded DM-RS for the PDSCH/PUSCH transmission, i.e., they may have the same number of symbols, antenna ports, sequence, and so on.

For PDSCH/PUSCH mapping Type-A, the front-loaded DM-RS starts from the third or fourth symbol of each slot (or each hop if frequency hopping is supported). For PDSCH/PUSCH mapping Type-B, the front-loaded DM-RS starts from the first symbol of the transmission duration. The number of additional DM-RS symbol(s) can be 1, 2, or 3 per network configuration.

Many antennas are envisioned in NR networks, while a relatively small number of antennas is at the handsets. Multi-user (MU) multiple input multiple output (MIMO) technology is used to take advantage of the spatial dimension of the multi-antenna system for high spectrum efficiency. To achieve good tradeoff between MU-MIMO performance and MU-MIMO overhead associated with the large number of layers for UEs, explicit indication of DM-RS antennas ports utilized for multiple UEs is supported. To support an even larger number of layers of single user (SU)/MU-MIMO transmissions, it is desirable to increase the number of orthogonal DM-RS ports without increasing the associated overhead. The associated overhead may include the time resources and/or frequency resources used for DM-RS transmission. For UEs under favorable conditions, e.g., short path propagation delay and high SINR, network enabling UEs to operate with additional orthogonal DM-RS ports may greatly improve system MU-MIMO spectrum efficiency.

To achieve high spectrum efficiency, MU-MIMO transmission and reception need to adapt dynamically to channel conditions, UE distribution, data traffic, and various other conditions. This implies that the number of MIMO layers and the occupied DM-RS ports for paired UEs (e.g., two intended UEs in DL MU-MIMO transmission) may vary with time (from transmission to transmission) and frequency (from resource block group (RBG) to RBG). More transmission layers may provide higher throughput at the cost of DM-RS overhead. In NR, in addition to the DM-RS ports used for data transmission (e.g., PDSCH or PUSCH) of an intended UE, DCI may be used to indicate the number of DM-RS code division multiplexing (CDM) group(s) that have no data mapped to their corresponding REs (resource elements). These DM-RS CDM groups may include, e.g., CDM group(s) of DM-RS ports of an intended UE, and may also include CDM group(s) of DM-RS ports for other UEs. The DCI can be used to indicate a MU-MIMO transmission and used to dynamically adjust the overhead associated with the MU-MIMO transmission. In the following, the terms of “DM-RS CDM group” and “CDM group” are used interchangeably, the terms of “DM-RS port”, “orthogonal CDM DM-RS ports”, “orthogonal DM-RS ports”, “orthogonal port” and “port” are used interchangeably, and the terms of “antenna port” and “port” are used interchangeably, unless otherwise provided.

To increase the number of DM-RS ports based on existing 5G NR DM-RS definitions/configurations, one possible approach is to double the maximum number of DM-RS ports supported in 5G NR Release 17 (Rel. 17) and previous releases (e.g., for legacy UEs), for both 1 and 2 OFDM symbol(s) configurations and both the Type-1 and Type-2 configurations. That is, for Type-1 DM-RS, there will be maximally 8 orthogonal ports for 1 OFDM symbol configuration (i.e., when one symbol is configured for DM-RS transmission) and 16 orthogonal ports for 2 OFDM symbols configuration (i.e., when two symbol are configured for DM-RS transmission) that can be supported; and for Type-2 DM-RS, there will be maximally 12 orthogonal ports for 1 OFDM symbol configuration and 24 orthogonal ports for 2 OFDM symbols configuration that can be supported. This approach has benefits that the Rel. 17 DM-RS configurations could be maximally preserved and reused, and the efforts for providing additional port(s) configuration and signaling indications could be minimized.

Embodiments of the present disclosure provide mechanisms to provide additional orthogonal DM-RS ports in addition to the orthogonal DM-RS ports supported according to the existing 5G NR DM-RS definitions/configurations (e.g., the Type-1/Type-2 configurations in 5G SU/MU-MIMO transmission described above). In some embodiments, the maximum number of the orthogonal DM-RS ports currently supported in the Type-1/Type-2 configurations may be doubled. Two embodiment schemes (i.e., scheme 1 and scheme 2) may be considered to achieve this, which will be described in the following using the Type-1 DM-RS configuration as an example. Those of ordinary skill in the art would recognize that the schemes may be similarly applied to the Type-2 configuration, and any other applicable DM-RS configuration(s). Further, scheme 1 and scheme 2 may be combined and applied to a DM-RS configuration to provide more DM-RS ports.

### Scheme 1 for Additional DM-RS Ports Configuration

In the embodiment scheme 1, for the Type-1 DM-RS configuration, the number of combs in the frequency domain may be kept to 2 and the number of cyclic shifts in the time domain may be doubled. Doubling the number of cyclic shifts in the time domain may be achieved through applying more OCC patterns in the frequency domain. In an embodiment, two (2) new OCC patterns may be introduced. By using the 2 new OCC patterns, together with the 2 legacy patterns, OCC patterns/sequences having a size/length of 4 may be formed, and four (4) orthogonal DM-RS ports may be formed for each comb. An example of the 4 OCC patterns may be [+1+1+1+1], [+1−1+1−1], [+1+j−1−j], [+1−j−1+j]. Other OCC sequences of length 4 may also be applicable for generating orthogonal DM-RS ports, for example, the 4 OCC patterns may be [+1+1+1+1], [+1−1+1−1], [+1+1−1−1], [+1−1−1+1].

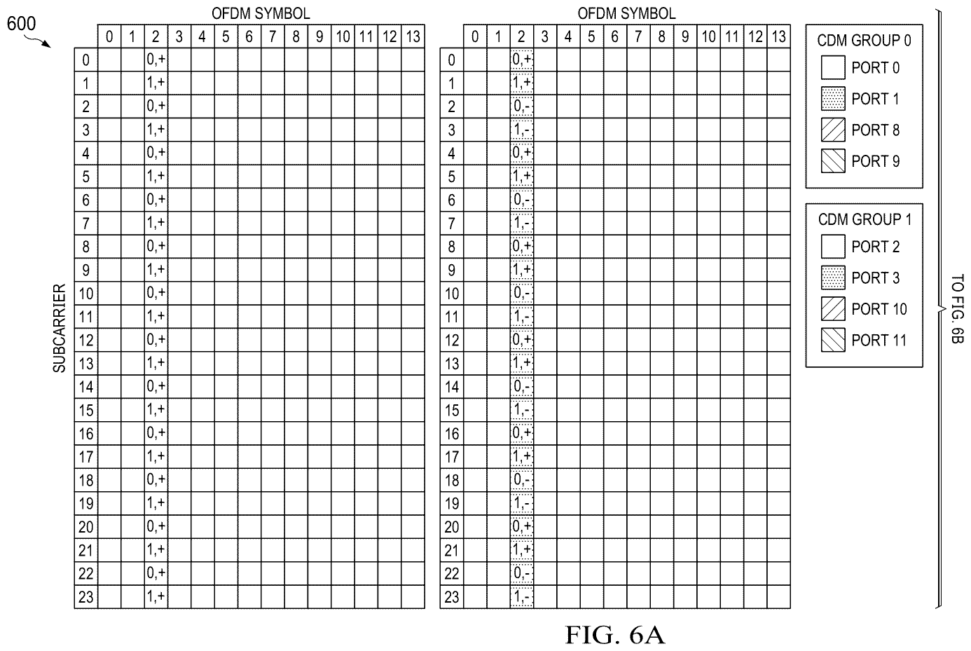

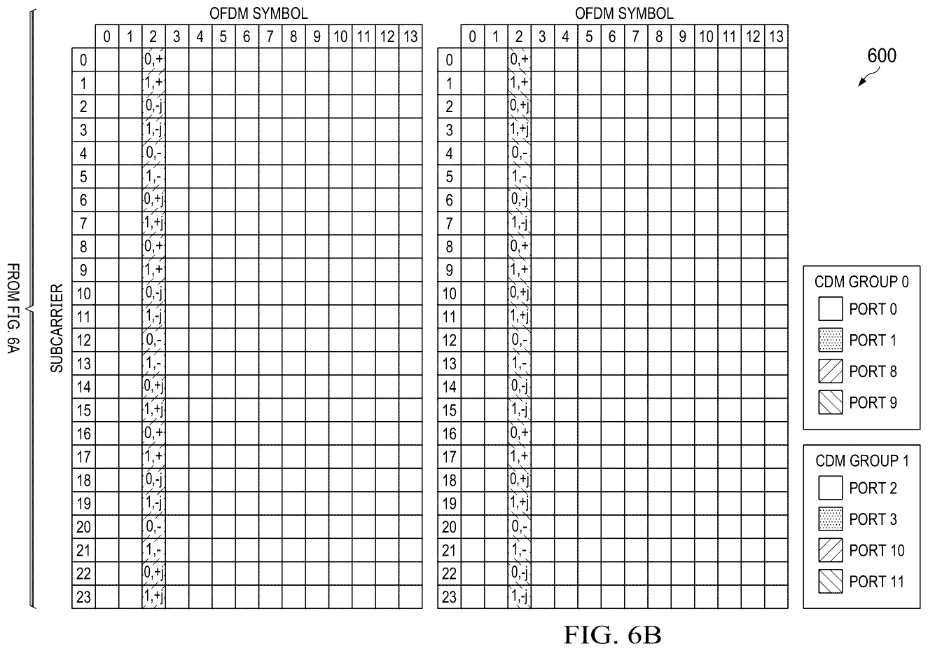

As an example, for the 1 OFDM symbol configuration (i.e., when one symbol is configured for DM-RS transmission), with the 4 patterns on each of the 2 combs, the embodiment scheme 1 provides 8 total orthogonal DM-RS ports, as shown in FIG. 6A and FIG. 6B. FIG. 6A and FIG. 6B is a diagram 600 showing an embodiment configuration for doubling the DM-RS ports of the Type-1 configuration with one symbol configured. Ports 0-3 are provided based on the Type-1 configuration, and ports 8-11 are additional ports provided based on scheme 1. The patterns of ports 0-3 are legacy port patterns defined in the current 5G NR specification, and patterns of ports 8-11 as shown are the additional port patterns.

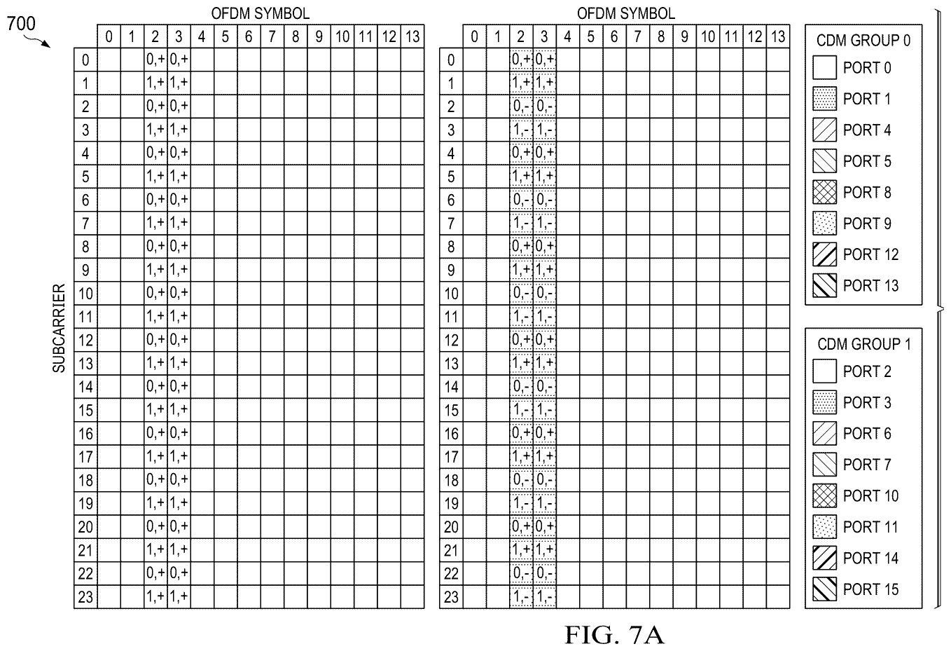

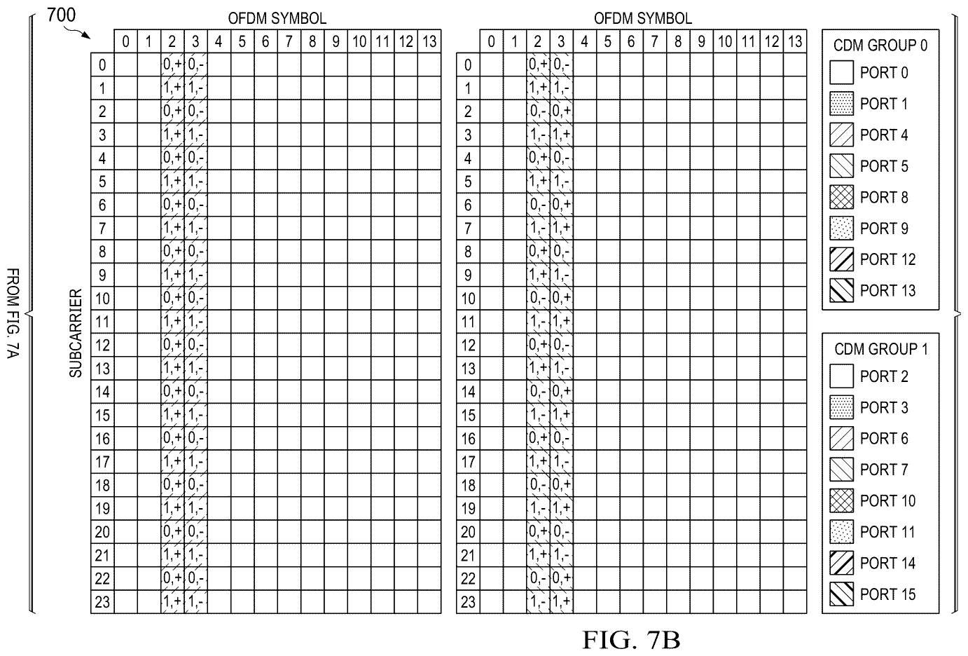

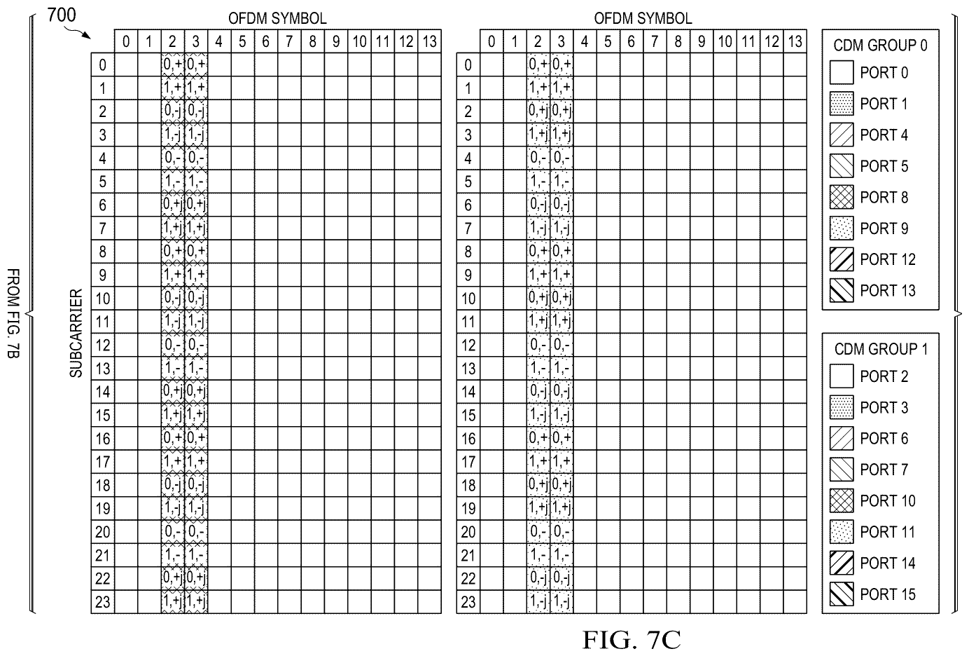

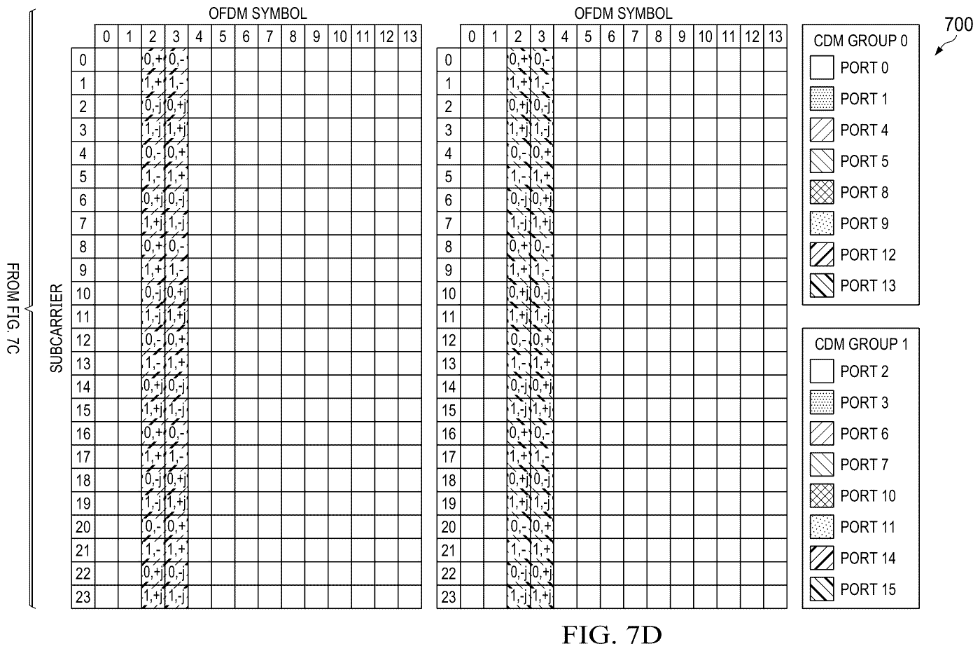

As another example, for the 2 OFDM symbols configuration (i.e., when two symbols are configured for DM-RS transmission), in addition to applying the two new OCC patterns in the frequency domain, the same time domain legacy OCCs of length 2, i.e., {[+1+1], [+1−1]}, may further be used to double the orthogonal DM-RS ports, giving a total of 16 orthogonal DM-RS ports, as shown in FIGS. 7A-7D, which is a diagram 700 showing an embodiment configuration for doubling the DM-RS ports of the Type-1 configuration with two symbols configured.

In the embodiment scheme 1, the number of CDM groups may remain to be the same as that in the Rel. 17 Type-1 DM-RS configuration. FIGS. 6A-6B and FIGS. 7A-7D show the pattern for each orthogonal port spread over 2 resource blocks. The pattern repeats every 2 resource blocks; however, the actual number of scheduled resource blocks for DM-RS transmission may not necessarily be a multiple of 2.

Therefore, by using scheme 1, the Type-1 configuration can support 8 ports with a signal OFDM symbol configured and 16 ports with double OFDM symbols configured. For description convenience, the ports provided by the Type-1 configuration in 5G NR Rel. 17 and previous releases may be referred to as a first set of Type-1 (DM-RS) ports, and the ports provided by the Type-1 configuration with scheme 1 applied may be referred to as a second set of Type-1 ports. The second set of Type-1 ports includes the first set of Type-1 ports and additional DM-RS ports added through scheme 1. Scheme 1 doubles the first set of Type-1 ports. The second set of Type-1 ports each may be assigned with an index p, where p=0, 1, . . . 15. For description convenience, port numbers 0-7 are used to refer to the legacy DM-RS ports, and port numbers 8-15 are used to refer to the additional DM-RS ports added by using scheme 1.

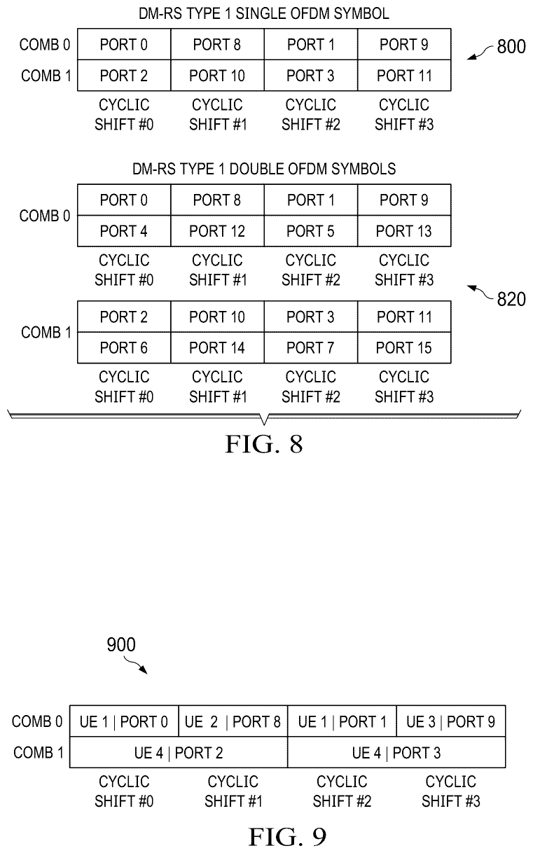

FIG. 8 shows example relative timing locations of the second set of Type-1 DM-RS ports obtained by transforming received DM-RS signals to the time domain. FIG. 8 includes a table 800 showing the relative timing locations of the second set of Type-1 ports when one OFDM symbol is configured (i.e., the ports shown in FIGS. 6A-6B). Four ports are provided on each of the two combs (comb 0 and comb 1), totaling eight ports. Table 820 in FIG. 8 shows the relative timing locations of the second set of Type-1 ports when two OFDM symbols are configured (i.e., the ports shown in FIGS. 7A-7D). Eight ports are provided on each of the two combs, totaling sixteen (16) ports. FIG. 8 also shows the cyclic shifts applied to these ports respectively.

In some embodiments, to map a DM-RS sequence to the resource elements (REs) for each DM-RS port indexed with p=0, 1, . . . , 15, based on the modified equations from Section 7.4.1.1.2 in TS 38.211, a UE may assume the mapping according to:

$${α}_{k , l}^{( p , u )} = {β}_{PDSCH}^{DMRS} {w}_{f}^{p} ( {k}^{′} ) {w}_{t} ( {l}^{′} ) r ( 4 n + {k}^{′} )$$

$$k = 8 n + 2 {k}^{′} + Δ Configuration type 1$$

$${k}^{′} = 0 , 1 , 2 , 3 Configuration type 1$$

$$l = \overline{l} + {l}^{′}$$

$$n = 0 , 1 …$$

where β_{PDSCH}^{DMRS} is a scaling factor, α_{k,l}^{(p,u)} is a resulting value of the DM-RS sequence to be mapped to resource element (k, l)_{p,u}, k and l are a subcarrier index and a symbol index, respectively, indicating the resource element, wₜ(l′) and the time domain related parameters, l̅ and l′, are defined in the same way, and are given by Tables 7.4.1.1.2-1, 7.4.1.1.2-2, 7.4.1.1.2-3, 7.4.1.1.2-4 and 7.4.1.1.2-5 in 5G NR TS 38.211 specification, which is hereby incorporated by reference in its entirety. r(n) is defined in section 7.4.1.1.1 of 5G NR 38.211 specification. w_{f}^{p}(k) for DM-RS can be calculated as:

$${w}_{f}^{p} ( {k}^{′} ) = {e}^{i \frac{2 π {pk}^{′}}{4}} .$$

Table 1 below shows example parameters used for the mapping. Table 1 is obtained by modifying the Table 7.4.1.1.2-1 in TS 38.211. As an example, the parameter “p” in Table 1 is associated with the DM-RS port indexes (0, 1, . . . , 15) and p=1000 +DM-RS port index. In each entry of Table 1, the parameter w_{f}(k′), k′=0, 1, 2, 3 indicates the frequency domain (FD)-OCC of length 4 associated with the corresponding parameter p in the entry and its associated DM-RS port (e.g., DM-RS port index=p−1000). The FD-OCC herein refers to an OCC applied in the frequency domain, e.g., applied to REs in the same OFDM symbol. For example, the entry for p=1008 indicates that the FD-OCC pattern [+1−j−1+j] is applied to DM-RS port 8, and the entry for p=1009 indicates that the FD-OCC pattern [+1+j−1−j] is applied to DM-RS port 9. In Table 1, the association of the DM-RS port indicated by the parameter “p” and the FD-OCC indicated by the parameter w_{f}(k′) is shown merely as an example. Other alternatives/variations to associate the DM-RS port and the FD-OCC are also possible. For example, the FD-OCC patterns for p=1008 and p=1009 shown in Table 1 may be switched such that FD-OCC pattern [+1+j−1−j] is applied to DM-RS port 8 and FD-OCC pattern [+1−j−1+j] is applied to DM-RS port 9. Similarly, the FD-OCC patterns for p=1010 and p=1011 may be switched. Similar switching may be applied to p=1012 and p=1013, as well as p=1014 and p=1015.

TABLE 1

| | CDM | | w_{f} (k′) | | | |
|---|---|---|---|---|---|---|
| p | group λ | Δ | k′ = 0 | k′ = 1 | k′ = 2 | k′ = 3 |
| 1000 | 0 | 0 | +1 | +1 | +1 | +1 |
| 1001 | 0 | 0 | +1 | −1 | +1 | −1 |
| 1002 | 1 | 1 | +1 | +1 | +1 | +1 |
| 1003 | 1 | 1 | +1 | −1 | +1 | −1 |
| 1004 | 0 | 0 | +1 | +1 | +1 | +1 |
| 1005 | 0 | 0 | +1 | −1 | +1 | −1 |
| 1006 | 1 | 1 | +1 | +1 | +1 | +1 |
| 1007 | 1 | 1 | +1 | −1 | +1 | −1 |
| 1008 | 0 | 0 | +1 | −j | −1 | +j |
| 1009 | 0 | 0 | +1 | +j | −1 | −j |
| 1010 | 1 | 1 | +1 | −j | −1 | +j |
| 1011 | 1 | 1 | +1 | +j | −1 | −j |
| 1012 | 0 | 0 | +1 | −j | −1 | +j |
| 1013 | 0 | 0 | +1 | +j | −1 | −j |
| 1014 | 1 | 1 | +1 | −j | −1 | +j |
| 1015 | 1 | 1 | +1 | +j | −1 | −j |

In Rel. 17, to achieve good tradeoff between the MU-MIMO performance and overhead associated with the potentially large number of layers for UEs, explicit indication of DM-RS antennas ports utilized for multiple UEs is supported. A DCI message, e.g., Format 1-1,is used to indicate, to a UE, the scheduled number of DM-RS ports, an index of each DM-RS port, and CDM groups of co-scheduling UE(s) for MU-MIMO transmission. Detailed DM-RS port(s) indexing, mapping and co-scheduling CDM group(s) may be obtained by reading an entry corresponding to an antenna port(s) bits value in the DCI message, from lookup tables in 5G NR TS 38.212 specification, i.e., Table 7.3.1.2.2-1 and Table 7.3.1.2.2-1A for Type-1 1 OFDM symbol configuration, Table 7.3.1.2.2-2 and Table 7.3.1.2.2-2A for Type-12 OFDM symbols configuration, Table 7.3.1.2.2-3 and Table 7.3.1.2.2-3A for Type-2 1 OFDM symbol configuration, and Table 7.3.1.2.2-4 and Table 7.3.1.2.2-4A for Type-2 2 OFDM symbol configuration.

Reducing either the DM-RS density in the frequency domain or cyclic shift duration in the time domain may cause MU-MIMO performance degradation for UEs in certain channel conditions, e.g., a channel having a long path propagation delay. Reducing DM-RS resource overhead for each port may be prone to poorer DM-RS channel estimation because of lower effective operating signal to interference and noise ratio (SINR). Thus, it is desirable for UEs to have the choice to operate under legacy DM-RS port(s) configuration, indexing, mapping, and indicating.

With the number of maximum orthogonal DM-RS ports doubled, the ports combination, signaling indications and message mapping grow substantially. If providing the additional orthogonal DM-RS ports is solely for MU-MIMO transmission, and Rel. 17 designs on ports combination, signaling indication and message mapping are satisfactory, it is desirable to leverage the legacy design as much as possible, and make necessary modifications as little as possible to minimize standard efforts for enjoying the performance enhancement brought by the additional orthogonal DM-RS ports.

Therefore, it would be appreciated that the design of port indexing, grouping, and signaling for scheme 1 considers backward compatibility with legacy UEs as much as possible, and avoids redesigning of port indexing, grouping, and signaling completely. If adding additional DR-MS ports in Rel. 18 is targeting MU-MIMO scenarios, it would be desirable that legacy DM-RS port indexing, grouping, and signaling may be reused as much as possible.

For the SU-MIMO scenarios, the legacy design may be reused. A UE may be scheduled with a few DM-RS ports by using the antenna port indexes in DCI format 1_1 as described in Clause 7.3.1.2 of [5, TS 38.212], which is hereby incorporated by reference in its entirety.

TS 38.212 specifies that, for DM-RS configuration type 1,
if a UE is scheduled with one codeword and assigned with the antenna port mapping with indices of {2, 9, 10, 11 or 30} in Table 7.3.1.2.2-1 and Table 7.3.1.2.2-2 of Clause 7.3.1.2 of [5, TS 38.212], or
if a UE is scheduled with one codeword and assigned with the antenna port mapping with indices of {2, 9, 10, 11 or 12} in Table 7.3.1.2.2-1A and {2, 9, 10, 11, 30 or 31} in Table 7.3.1.2.2-2A of Clause 7.3.1.2 of [5, TS 38.212], or
if a UE is scheduled with two codewords,
   the UE may assume that all the remaining orthogonal antenna ports are not associated with transmission of PDSCH to another UE.

In some embodiments, for the SU/MU-MIMO scenarios and the DM-RS configuration type 1 with scheme 1 applied, a UE may be configured with two modes of operation for DM-RS port(s) indication: Mode 1 and Mode 2. When the network indicates DM-RS ports to be used in communication with the UE, the UE may interpret the indication based on its mode. When operating in mode 1, the DM-RS ports usable by the UE may only include the first set of Type-1 ports supported by the type-1 configuration; when operating in mode 2, the DM-RS ports usable by the UE may include the second set of Type-1 ports generated according to scheme 1.

### Mode 1: Legacy DM-RS CDM Port(s)

In this mode of operation, a DCI message may be transmitted and interpreted in the same way as described in Section 7.3.1.2.2 of TS 38.212 and Section 5.1.6.2 of TS 38.214 which is hereby incorporated by reference in its entirety. The definitions of the DM-RS ports follow the legacy definitions. The DCI message may indicate one or more of the first set of Type-1 ports. The usage for this mode may be for better handling of longer propagation path delay or backward compatible with legacy UEs.

### Mode 2: Double DM-RS CDM Port(s)

In this mode of operation, scheme 1 is applied, and the number of DM-RS ports is doubled and the time duration corresponding to its cyclic shift time location of each DM-RS port is halved. The DM-RS ports in this mode include the second set of Type-1 ports as described above. This mode may be used for multiplexing more UE transmissions simultaneously.

In some embodiments, to indicate the orthogonal DM-RS ports using DCI for mode 2 operation, a new bit may be defined in addition to a legacy DCI message, or a bit in the legacy DCI message may be defined with a new definition. This bit may be referred to as a DM-RS port offset bit, and in one embodiment, may be designed as follows:
If the DM-RS port offset bit is 0, no port offset shall be added;
If the DM-RS port offset bit is 1, add 8 to the port index(es) of the corresponding entry in the corresponding lookup table (e.g., 7.3.1.2.2-1, 7.3.1.2.2-1A, 7.3.1.2.2-2 and 7.3.1.2.2-2A in TS 38.212);
Alternatively, the bit value of the DM-RS port offset bit being 1 indicates that no port offset shall be added, and the bit value of the DM-RS port offset bit being 0 indicates adding 8 to the port index(es).

For example, the maximum length of OFDM symbols (e.g., the maximum number of OFDM symbols for front-loaded DM-RS) is 2, and Table 7.3.1.2.2-2 in 38.212 (shown below as Table 2) is used for table lookup for DM-RS ports. Assuming that one codeword is enabled and the antenna port(s) bits have a value 26 (i.e., value=26 in Table 2), DM-RS ports 0,1,4 are indicated according to Table 2. If the DM-RS port offset bit is 0, a UE may expect the DM-RS transmission on the DM-RS ports 0,1,4. If the DM-RS port offset bit is 1, the UE may expect the DM-RS transmission on ports 8,9,12 by adding 8 to 0,1,4.

TABLE 2
Table 7.3.1.2.2-2 Antenna port(s) (1000 + DMRS port),
dmrs-Type = 1, maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of | | | | of | | |
| | DMRS | | Number | | DMRS | | Number |
| | CDM | | of | | CDM | | of |
| | group(s) | | front- | | group(s) | | front- |
| | without | DMRS | load | | without | DMRS | load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 2, 3, 4, 6 | 2 |
| 2 | 1 | 0, 1 | 1 | 2 | 2 | 0, 1, 2, 3, 4, | 2 |
| | | | | | | 5, 6 | |
| 3 | 2 | 0 | 1 | 3 | 2 | 0, 1, 2, 3, 4, | 2 |
| | | | | | | 5, 6, 7 | |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

In some embodiments, a new lookup table may be created providing DM-RS ports for the mode 2 operation when the DM-RS port offset bit is 1. Using the same example as above where value=26, if the DM-RS port offset bit is 1, the UE may read the DMRS port(s) index(es) directly from the new lookup table, e.g., Table 3 below, which is obtained by modifying Table 7.3.1.2.2-2 in 38.212. Table 7.3.1.2.2-1, 7.3.1.2.2-1A and 7.3.1.2.2-2A may be modified similarly.

TABLE 3

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of DMRS | | Number | | of DMRS | | Number |
| | CDM | | of | | CDM | | of |
| | group(s) | | front- | | group(s) | | front- |
| | without | DMRS | load | | without | DMRS | load |
| Value | data | port(s) | symbols | Value | data | port(s) | symbols |
| 0 | 1 | 8 | 1 | 0 | 2 | 0-4 | 2 |
| 1 | 1 | 9 | 1 | 1 | 2 | 0, 1, 2, 3, 4, 6 | 2 |
| 2 | 1 | 0, 1 | 1 | 2 | 2 | 0, 1, 2, 3, 4, | 2 |
| | | | | | | 5, 6 | |
| 3 | 2 | 8 | 1 | 3 | 2 | 0, 1, 2, 3, 4, 5, | 2 |
| | | | | | | 6, 7 | |
| 4 | 2 | 9 | 1 | 4-31 | reserved | reserved | reserved |
| 5 | 2 | 10 | 1 | | | | |
| 6 | 2 | 11 | 1 | | | | |
| 7 | 2 | 8, 9 | 1 | | | | |
| 8 | 2 | 10, 11 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 8 | 2 | | | | |
| 13 | 2 | 9 | 2 | | | | |
| 14 | 2 | 10 | 2 | | | | |
| 15 | 2 | 11 | 2 | | | | |
| 16 | 2 | 12 | 2 | | | | |
| 17 | 2 | 13 | 2 | | | | |
| 18 | 2 | 14 | 2 | | | | |
| 19 | 2 | 15 | 2 | | | | |
| 20 | 2 | 8, 9 | 2 | | | | |
| 21 | 2 | 10, 11 | 2 | | | | |
| 22 | 2 | 12, 13 | 2 | | | | |
| 23 | 2 | 14, 15 | 2 | | | | |
| 24 | 2 | 8, 12 | 2 | | | | |
| 25 | 2 | 10, 16 | 2 | | | | |
| 26 | 2 | 8, 9, 12 | 2 | | | | |
| 27 | 2 | 10, 11, 14 | 2 | | | | |
| 28 | 2 | 8, 9, 12, 13 | 2 | | | | |
| 29 | 2 | 10, 11, 14, 15 | 2 | | | | |
| 30 | 2 | 0, 2, 4, 6 | 2 | | | | |
| 31 | Reserved | Reserved | Reserved | | | | |

In one embodiment, one of the two modes of operation may be configured to a UE specifically and activated, e.g., through high layer signaling such as radio resource control (RRC) signaling. In another embodiment, the two modes of operation may be configured to a UE through high layer (e.g., RRC) signaling, and one of the two modes may be activated by, e.g., RRC signaling, a medium access control-control element (MAC-CE), or DCI. For network flexible scheduling, it is desirable for the network to have the capability to co-schedule MU-MIMO UEs with mixed operating modes.

In some embodiments, the network may signal a UE to switch between these two modes dynamically by defining a new bit in addition to the legacy DCI message, or defining a bit in the legacy DCI message with new definition. The bit may be referred to as a DM-RS operation mode bit, and may be defined as follows:
if the DM-RS operation mode bit is 1, the UE shall operate in mode 1;
if the DM-RS operation mode bit is 0, the UE shall operate in mode 2;
or alternatively, if the DM-RS operation mode bit is 0, the UE shall operate in mode 1; and if the DM-RS operation mode bit is 1, the UE shall operate in mode 2.

As an example, assuming the maximum length of OFDM symbols is 1, Table 7.3.1.2.2-1 in TS 38.212 (shown below as Table 4) may be used for table lookup.

TABLE 4
Table 73.1.2.2-1: Antenna port(s)
(1000 + DMRS port),
dmrs-Type = 1, maxLength = 1
One Codeword:
Codeword 0 enabled,
Codeword 1 disabled

| | Number of | |
|---|---|---|
| | DMRS CDM | |
| | group(s) | DMRS |
| Value | without data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12-15 | Reserved | Reserved |

In this example, 4 UEs (UE1-UE4) are scheduled for MU-MIMO transmission, and the network may signal a mode to each UE, indicating the UE to operate in the signaled mode. Each UE determines the DM-RS ports based on the signaled mode, an indicated value (antenna port bits value) corresponding to DM-RS port(s) (e.g., “Value” in Table 4), an indicated DM-RS port offset bit value, and the lookup table, as follows:
UE1 is signaled to operate in mode 2, and signaled with antenna port bits value 7 and DM-RS port offset bit value 0 (indicating that no port offset shall be added as an example). UE1 shall expect DM-RS transmission on ports 0 and 1 of the second set of Type-1 ports based on Table 4.
UE2 is signaled to operate in mode 2, and signaled with antenna port bits value 3 and DM-RS port offset bit value 1 (indicating to add 8 to the port index(es) of a corresponding entry in the lookup table, as an example). UE2 shall expect DM-RS transmission on port 8based on Table 4 (i.e., port 0+8=port 8).
UE3 is signaled to operate in mode 2, and signaled with antenna port bits value 4 and DM-RS port offset bit value 1. UE3 shall expect DM-RS transmission on port 9 based on Table 4 (i.e., port 1+8=port 9).
UE4 is signaled to operate in mode 1, and signaled with antenna port bits value 8 and DM-RS port offset bit value 0. UE4 shall expect DM-RS transmission on ports 2 and 3 of legacy DM-RS port definitions.

FIG. 9 is a diagram 900 showing an embodiment DM-RS ports assignment for UE1-UE4 above in the cyclic shift and comb domain. UE4 has a legacy duration, which facilitates handling of longer propagation path delay or backward compatibility.

### Scheme 2 Additional DM-RS Ports Configuration

In some embodiments, to provide additional DM-RS ports for the Type-1 configuration, the number of combs in the frequency domain may be increased, e.g., from 2 to 4, and the number of cyclic shifts in the time domain may be kept to 2. Doubling the number of combs in the frequency domain reduces the DM-RS RE density by half (subcarriers occupied by each DM-RS port in a resource block is reduced by half). Each comb carries 2 orthogonal DM-RS ports by cyclic shift CDM (e.g., using frequency domain OCC patterns), and the 4 combs together give 8 ports for the single OFDM symbol configuration. For the double OFDM symbols configuration, the same time domain legacy OCC of length 2, i.e., {[+1+1], [+1−1]}, may be used to double the orthogonal DM-RS ports, which gives a total of 16 orthogonal DM-RS ports.

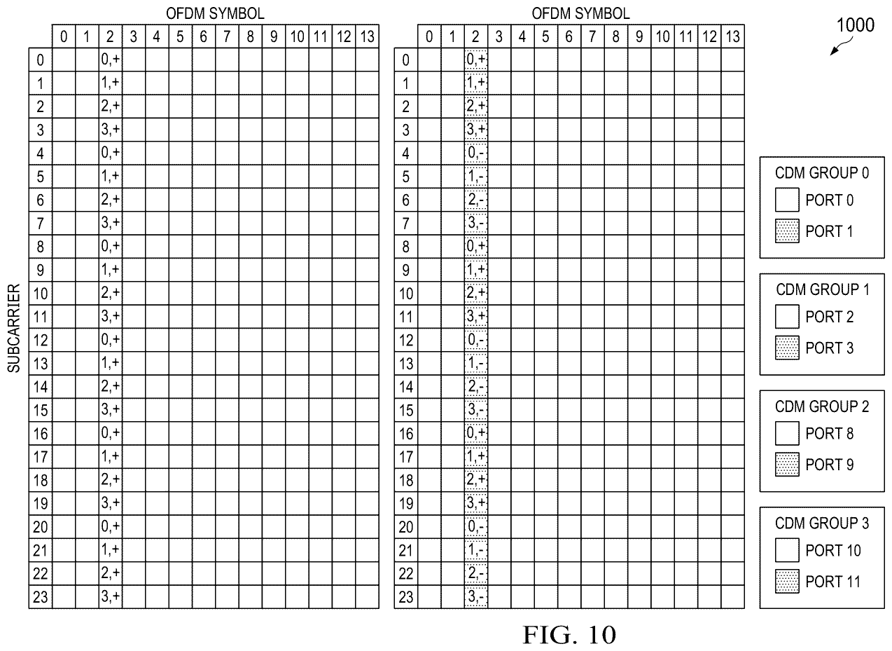

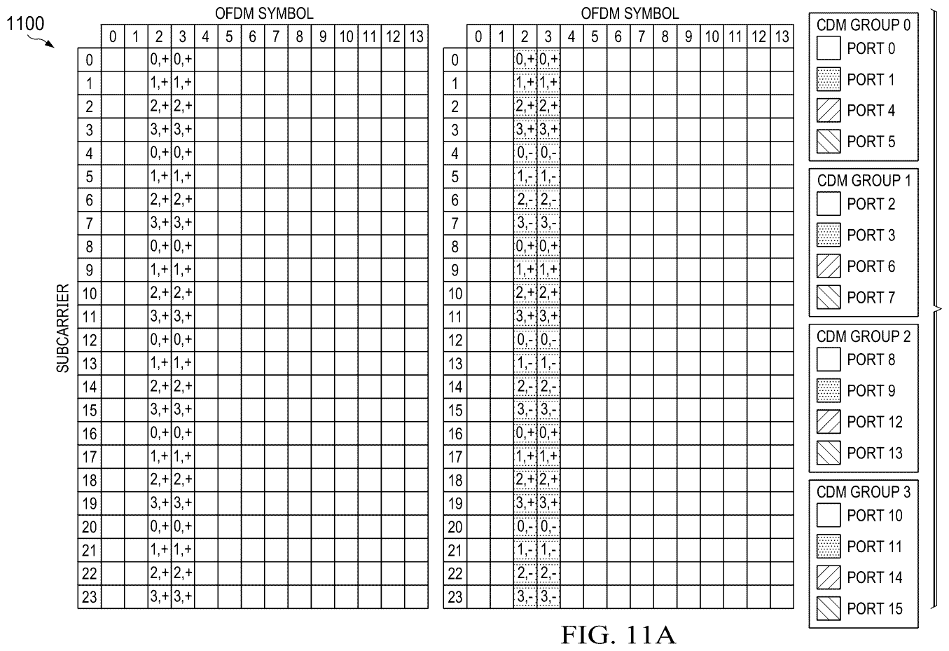

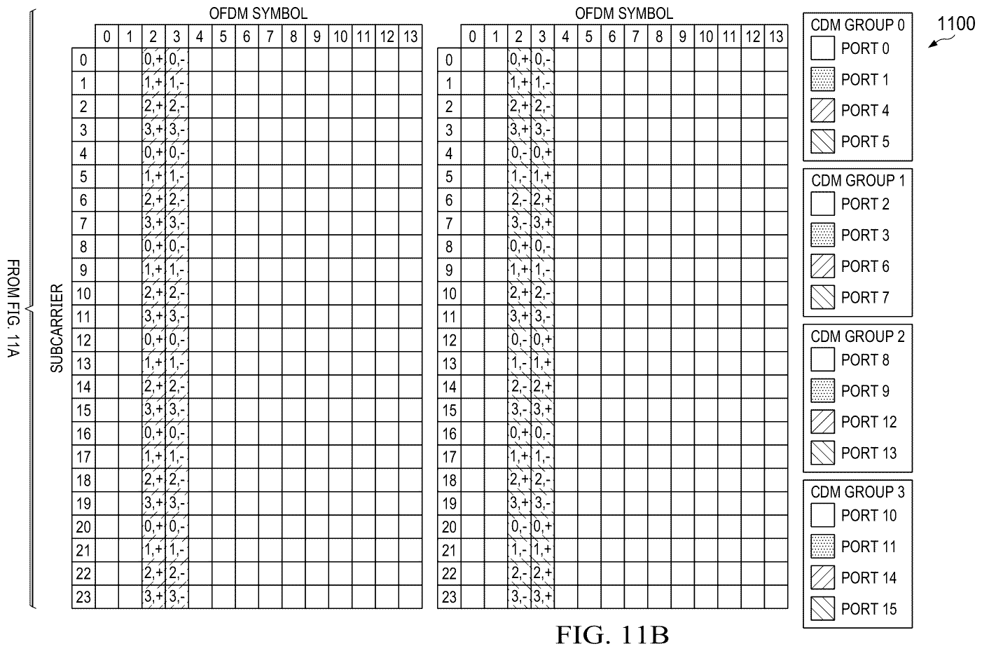

FIGS. 10-11 show a pattern of each orthogonal port spread over 2 resource blocks, where the scheme 2 with 4 combs is applied for the Type-1 configuration. Note that the patterns repeat every 2 resource blocks although the number of the actual scheduled resource blocks for DM-RS transmission is not necessarily a multiple of 2. FIG. 10 is a diagram 1000 showing an embodiment configuration of doubling the DM-RS ports for the Type-1 DM-RS configuration with a single OFDM symbol configured based on scheme 2. The frequency density of each DM-RS port is halved compared to the NR legacy DM-RS configuration. Since the number of combs is doubled from 2 to 4, the number of CDM groups is also doubled from 2 to 4 (i.e., CDM groups 0-3 as shown). In this example, a DM-RS port index is mapped to a CDM group index in a way such that ports 0-3 have the same comb offsets as the legacy DM-RS configurations, i.e., ports 0,1 are on comb offset 0 corresponding to CDM group 0, ports 2,3 are on comb offset 1 corresponding to CDM group 1. For the additional DM-RS port indexes, ports 8,9 are on comb offset 2 corresponding to CDM group 2, and ports 10,11 are on comb offset 3 corresponding to CDM group 3.

FIGS. 11A-11B is a diagram 1100 showing an example configuration of doubling the DM-RS ports for the Type-1 DM-RS configuration with a double OFDM symbols configured based on scheme 2. The frequency density of each DM-RS port is halved compared to the NR legacy DM-RS configuration. Since the number of combs is doubled from 2 to 4, the number of CDM groups is also doubled from 2 to 4 (i.e., CDM groups 0-3 as shown). In this example, a DM-RS port index is mapped to a CDM group index in a way such that ports 0-7 have the same comb offsets as the legacy DM-RS configurations, i.e., ports 0,1,4,5 are on comb offset o corresponding to CDM group 0, ports 2,3,6,7 are on comb offset 1 corresponding to CDM group 1. For the additional DM-RS port index, ports 8,9,12,13 are on comb offset 2 corresponding to CDM group 2, and ports 10,11,14,15 are on comb offset 3 corresponding to CDM group 3.

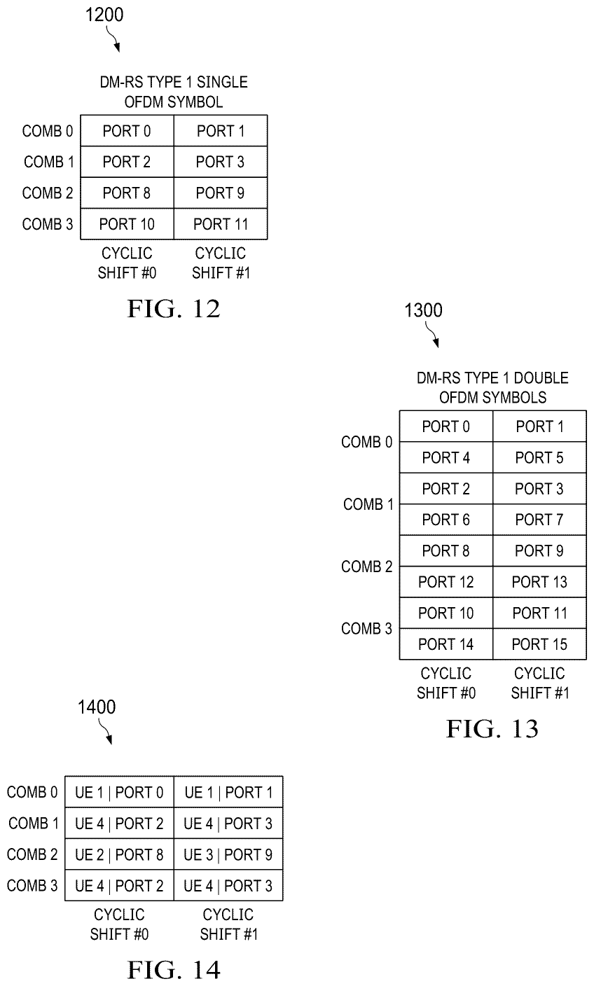

FIG. 12 is a diagram 1200 showing example relative timing locations of the DM-RS ports in the example of FIG. 10, which is obtained by transforming received DM-RS signals to the time domain. FIG. 12 shows the 8 DM-RS ports with their corresponding combs in the frequency domain and cyclic shifts in the time domain.

FIG. 13 is a diagram 1300 showing example relative timing locations of the DM-RS ports in the example of FIGS. 11A-11B, which is obtained by transforming received DM-RS signals to the time domain. FIG. 13 shows the 16 DM-RS ports with their corresponding combs in the frequency domain and cyclic shift in the time domain.

In some embodiments, to map the DM-RS sequence to the resource elements for the DM-RS ports with indexes p=0, 1, 2, . . . , 15 in scheme 2, based on the modified equations from Section 7.4.1.1.2 in TS 38.211, a UE may assume the mapping according to:

$${α}_{k , l}^{( p , u )} = {β}_{PDSCH}^{DMRS} {w}_{f} ( {k}^{′} ) {w}_{t} ( {l}^{′} ) r ( 2 n + {k}^{′} )$$

$$k = 8 n + 2 {k}^{′} + Δ Configuration type 1$$

$${k}^{′} = 0 , 1 Configuration type 1$$

$$l = \overline{l} + {l}^{′}$$

$$n = 0 , 1 …$$

where wₜ(l′) and the time domain related parameters, l̅ and l′, are defined in the same way, and are given by Tables 7.4.1.1.2-1, 7.4.1.1.2-2, 7.4.1.1.2-3, 7.4.1.1.2-4 and 7.4.1.1.2-5 in 5G NR TS 38.211 specification. r(n) is defined in section 7.4.1.1.1 of 5G NR TS 38.211 specification. Table 5 below shows example parameters used for the mapping. The table is obtained by modifying the Table 7.4.1.1.2-1 in TS 38.211.

TABLE 5

| | CDM | | w_{f} (k′) | |
|---|---|---|---|---|
| p | group λ | Δ | k′ = 0 | k′ = 1 |
| 1000 | 0 | 0 | +1 | +1 |
| 1001 | 0 | 0 | +1 | −1 |
| 1002 | 1 | 1 | +1 | +1 |
| 1003 | 1 | 1 | +1 | −1 |
| 1004 | 0 | 0 | +1 | +1 |
| 1005 | 0 | 0 | +1 | −1 |
| 1006 | 1 | 1 | +1 | +1 |
| 1007 | 1 | 1 | +1 | −1 |
| 1008 | 2 | 2 | +1 | +1 |
| 1009 | 2 | 2 | +1 | −1 |
| 1010 | 3 | 3 | +1 | +1 |
| 1011 | 3 | 3 | +1 | −1 |
| 1012 | 2 | 2 | +1 | +1 |
| 1013 | 2 | 2 | +1 | −1 |
| 1014 | 3 | 3 | +1 | +1 |
| 1015 | 3 | 3 | +1 | −1 |

Similarly to those described with respect to scheme 1, the design of port indexing, grouping, and signaling for scheme 2 also needs to strive for backward compatible with legacy UEs as much as possible, and to avoid redesigning of port indexing, grouping, and signaling completely. When the purpose of adding additional DR-MS ports in Rel. 18 is solely targeting MU-MIMO instead of SU-MIMO scenarios, legacy DM-RS port indexing, grouping, and signaling may be reused as much as possible.

For the SU-MIMO scenario, the design for legacy may be reused. A UE may be scheduled with a few DM-RS ports by the antenna port index(es) in DCI format 1_1 as described in Clause 7.3.1.2 of [5, TS 38.212].

TS 38.212 specifies that, for DM-RS configuration type 1,
if a UE is scheduled with one codeword and assigned with the antenna port mapping with indices of {2, 9, 10, 11 or 30} in Table 7.3.1.2.2-1 and Table 7.3.1.2.2-2 of Clause 7.3.1.2 of [5, TS 38.212], or
if a UE is scheduled with one codeword and assigned with the antenna port mapping with indices of {2, 9, 10, 11 or 12} in Table 7.3.1.2.2-1A and {2, 9, 10, 11, 30 or 31} in Table 7.3.1.2.2-2A of Clause 7.3.1.2 of [5, TS 38.212], or
if a UE is scheduled with two codewords, the UE may assume that all the remaining orthogonal antenna ports are not associated with transmission of PDSCH to another UE.

For description convenience, the ports provided by the Type-1 configuration with scheme 2 applied may be referred to as a third set of Type-1 ports. The third set of Type-1 ports includes the first set of Type-1 ports and additional DM-RS ports added through scheme 2. In some embodiments, for the SU/MU-MIMO scenario and the DM-RS configuration type 1 with scheme 2 applied, the UE may be configured with three modes of operation for the DM-RS port(s) indication:

### Mode 1: Legacy DM-RS CDM Port(s)

In this mode of operation, a DCI message is transmitted and interpreted in the same way as described in Section 7.3.1.2.2 of TS 38.212 and Section 5.1.6.2 of TS 38.214. The definitions of the DM-RS ports follow the legacy definitions. The DCI message may indicate one or more of the first set of Type-1 ports. The usage for this mode may be for better handling of longer propagation path delay or backward compatible with legacy UEs.

### Mode 2: Double DM-RS CDM Ports and Double CDM Groups Without Data

In this mode of operation, scheme 2 is applied, and the number of DM-RS CDM ports doubles and the frequency density of each DM-RS CDM port is halved. The number of DM-RS CDM groups without data is also doubled based on the scheduled number of DM-RS CDM groups without data. The DM-RS ports in this mode include the third set of Type-1 ports as described above. The usage for this mode may be for multiplexing more UE transmission simultaneously.

### Mode 3: Double DM-RS CDM Ports Only

In this mode of operation, the number of DM-RS CDM ports is doubled and the frequency density of each DM-RS CDM port is halved. The number of DM-RS CDM groups without data is not doubled. The DM-RS ports in this mode include the third set of Type-1 ports as described above. This mode may be used for high spectrum efficiency and reducing UE DM-RS overlapping in frequency domain.

To indicate the DM-RS ports for mode 2 and 3, a new bit, i.e., a DM-RS port offset bit, may be defined in addition to the legacy DCI message, or a bit in the legacy DCI message may be defined with new definition. In an embodiment, the bit may be defined as follows:
if the DM-RS port offset bit is 0, no port offset shall be added;
if the DM-RS port offset bit is 1, add 8 to the port index(es) of a corresponding entry in a corresponding lookup table (e.g., Table 7.3.1.2.2-1, 7.3.1.2.2-1A, 7.3.1.2.2-2, or 7.3.1.2.2-2A in TS 38.212);
alternatively, the bit value of the DM-RS port offset bit being 1 indicates that no port offset shall be added, and the bit value of the DM-RS port offset bit being 0 indicates adding 8 to the port index(es).

For DM-RS type 1 with doubled ports with scheme 2 applied, the maximum number of DM-RS CDM groups without data is increased from 2 to 4. The indication of the number of DM-RS CDM group(s) without data also changes accordingly. Mode 2 and mode 3 are configured to handle this situation differently.

For mode 2, the network schedules multiple UEs for simultaneous transmission. In an embodiment, a UE may determine the number of CDM groups and the DM-RS ports as described in the following. The UE may derive DM-RS port(s) transmission information according to the antenna port(s) bits and the DM-RS port offset bit indicated in received DCI signaling. The UE may search a lookup table and read the entry in the lookup table corresponding to the received antenna port(s) bits. The UE may derive the number of CDM groups without data by always doubling the corresponding number in the entry. The additional DM-RS CDM group index(es) without data may be obtained by adding 2 to the DM-RS CDM group index(es) in the entry.

For example, if the configuration of DM-RS is type 1 and the maximum length of OFDM symbols is 2, then Table 7.3.1.2.2-2 in TS 38.212 (Table 2 above) may be used for table lookup. In this example, one codeword is enabled and the antenna port(s) bits have a value 26. From the entry corresponding to value 26 in the lookup table (Table 2), the indicated DM-RS ports are 0,1,4, and the indicated number of DM-RS CDM groups without data is 2, i.e. two DM-RS CDM groups with indexes {0,1}. Then the UE doubles the number of 2 to get a new number of DM-RS CDM groups without data, which is 4. The UE may then add 2 to {0,1} to obtain two new indexes of DM-RS CDM groups without data, i.e., {2,3}, and combine it with group indexes {0,1} to get the final DM-RS CDM groups without data indexes, i.e., {0,1,2,3}. If the DM-RS port offset bit is 0, the UE shall expect the DM-RS transmission on ports 0,1,4. If the DM-RS port offset bit is 1, the UE shall add 8 to {0,1,4},and expect the DM-RS transmission on ports 8,9,12.

In some embodiments, if the DM-RS port offset bit is 0, the UE may read the DM-RS port(s) index(es) and the number of DM-RS CDM group(s) without data directly from a new lookup table, which is obtained by modifying Table 7.3.1.2.2-2. If the DM-RS port offset bit is 1, the UE may read the DM-RS port(s) index(es) and the number of DM-RS CDM group(s) without data directly from another new lookup table x which is obtained by modifying Table 7.3.1.2.2-2. Table 7.3.1.2.2-1, 7.3.1.2.2-1A and 7.3.1.2.2-2A may be modified similarly.

For mode 3, the network schedules multiple UE for simultaneous transmission. In some embodiments, a UE may derive DM-RS port(s) transmission information according to the antenna port(s) bits and the DM-RS port offset bit indicated in received DCI signaling. The UE may search a lookup table and read the entry in the lookup table corresponding to the received antenna port(s) bits. If the DM-RS port offset bit is 0, the DM-RS CDM group index(es) without data is the same as that of the entry. If the DM-RS port offset bit is 1, the DM-RS CDM group index(es) without data may be derived by adding 2 to DM-RS CDM group index(es) in the entry.

For example, if the configuration of DM-RS is type 1 and the maximum length of OFDM symbols is 2, then table 7.3.1.2.2-2 in TS 38.212 (Table 2 above) may be used for table lookup. In this example, one codeword is enabled and the antenna port(s) bits have a value 26. From the entry corresponding to value 26 in the lookup table (Table 2), the indicated DM-RS ports are 0, 1, 4, and the number of DM-RS CDM groups without data is 2, i.e., two DM-RS CDM groups with indexes {0,1}. If the DM-RS port offset bit is 0, the UE may derive the indexes of the DM-RS CDM groups without data directly from the indicated value {0,1} (based on the number of CDM group(s) without data and the indicated DMRS port(s)) and expect DM-RS transmission on ports 0, 1, 4. If the DM-RS port offset bit is 1, the UE adds 2 to {0,1} to get indexes of the final DM-RS CDM groups without data, i.e., {2,3}, and shall expect the DM-RS transmission on ports 8, 9, 12 by adding 8 to ports 0, 1, 4.

In some embodiments, if the DM-RS port offset bit is 0, the UE may read the DM-RS port(s) index(es) and the number of DM-RS CDM group(s) without data directly from a new lookup, which may be obtained by modifying Table 7.3.1.2.2-2. If the DM-RS port offset bit is 1, the UE may read the DM-RS port(s) index(es) and the number of DM-RS CDM group(s) without data directly from another new lookup table x which may be obtained by modifying Table 7.3.1.2.2-2. Table 7.3.1.2.2-1, 7.3.1.2.2-1A and 7.3.1.2.2-2A may be modified similarly.

In one embodiment, one of the three modes of operations may be configured to each UE specifically and activated through high layer signaling, e.g., RRC signaling. In another embodiment, one of mode combinations, e.g., the mode combination of modes 1 and 2, or the mode combination modes 1 and 3, may be configured to each UE through high layer signaling, e.g., RRC signaling, and one mode of the two modes in the configured mode combination may be activated by, e.g., RRC signaling, a MAC-CE or DCI.

In some embodiments, the network may dynamically signal a UE to switch between one of the two modes within the configured mode combination, i.e., modes 1 and 2, or modes 1 and 3, by defining a new bit in addition to the legacy DCI message, or defining a bit in the legacy DCI message with new definition. The bit may be referred to as a DM-RS operation mode bit.

When the bit is configured for the mode combination of modes 1 and 2, the bit may be defined as follows, as an example:
if the DM-RS operation mode bit is 1, the UE shall operate in mode 1;
if the DM-RS operation mode bit is 0, the UE shall operate in mode 2;
or, alternatively, if the DM-RS operation mode bit is 0, the UE shall operate in mode 1; and if the DM-RS operation mode bit is 1, the UE shall operate in mode 2.

When the bit is configured for the mode combination of modes 1 and 3, the bit may be defined as follows, as an example:
if the DM-RS operation mode bit is 1, the UE shall operate in mode 1;
if the DM-RS operation mode bit is 0, the UE shall operate in mode 3;
or alternatively, if the DM-RS operation mode bit is 0, the UE shall operate in mode 1; and if the DM-RS operation mode bit is 1, the UE shall operate in mode 3.

As an example, assuming that the maximum length of OFDM symbols is 1, Table 7.3.1.2.2-1 in 38.212 (Table 4 above) may be used for table lookup. For a case where 4 UEs are scheduled for MU-MIMO transmission, the network may signal a mode to each UE. Each UE may determine the DM-RS ports based on the signaling from the network as follows:
UE1 is signaled to operate in mode 2, and signaled with antenna port bits value 7 and DM-RS port offset bit value 0 (indicating that no port offset shall be added as an example). UE1 shall expect DM-RS transmission on ports 0 and 1 on comb 0.
UE2 is signaled to operate in mode 2, and signaled with antenna port bits value 3 and DM-RS port offset bit value 1 (indicating to add 8 to the port(s) index(es) of the lookup table as an example). UE2 shall expect DM-RS transmission on ports 8 (port 0+8) on comb 2.
UE3 is signaled to operate in mode 2, and signaled with antenna port bits value 4 and DM-RS port offset bit value 1. UE3 shall expect DM-RS transmission on ports 9 (port 1+8) on comb 2.
UE4 is signaled to operate in mode 1, and signaled with antenna port bits value 8 and DM-RS port offset bit value 0. UE4 shall expect DM-RS transmission on ports 2 and 3 on comb 1 of legacy DM-RS port definition (Comb 1 and 3 in new DM-RS ports definition).

FIG. 14 is a diagram 1400 showing the DM-RS ports assignment in the cyclic shift and comb domain for UE1-UE4 of the above example. UEs4 has legacy duration for better handling of longer propagation path delay or backward compatibility.

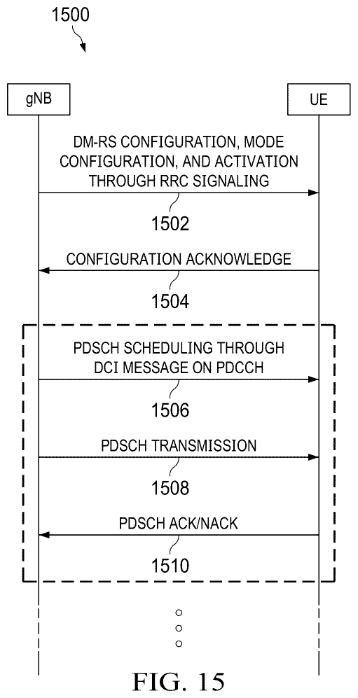

For the operations of modes of scheme 1 and scheme 2, FIGS. 15-17 show the corresponding flowcharts. FIGS. 15-17 provide embodiment methods for configuring modes and activating a mode for a UE, including message exchanges between the UE and a gNB. The embodiment methods may be applied to the two modes of operation under scheme 1 and the three modes of operation under scheme 2. The embodiment methods as shown use PDSCH transmission as an example merely for illustration purposes, and may also be applied for PUSCH and other applicable channel/signal transmissions.

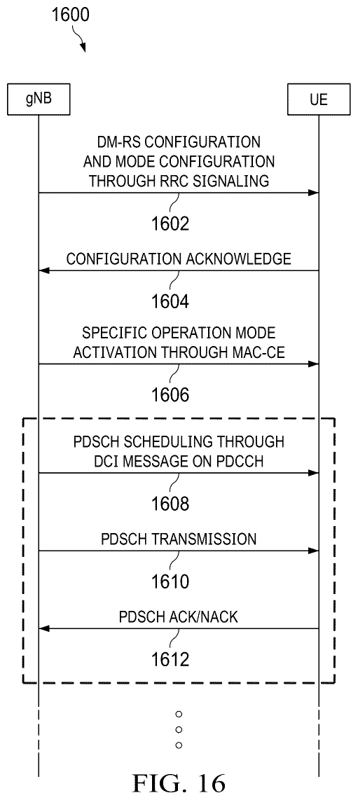

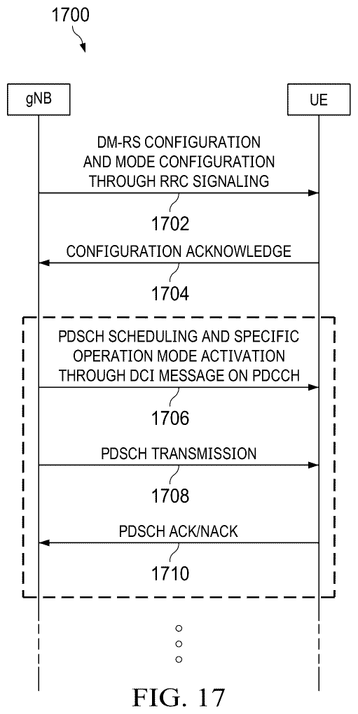

FIG. 15 is a flowchart of an embodiment method 1500, highlighting mode configuration and activation through RRC signaling. The gNB may send a DM-RS configuration, and a mode configuration to the UE through RRC signaling, and activate one of configured two modes for the UE through RRC signaling (step 1502). For example, the mode configuration may configure the two modes of operation under scheme 1, or a mode combination under scheme 2 (e.g., mode 1 and mode 3, or mode 1 and mode 2) for the UE, and one of the two modes may be activated/indicated for the UE to use. The configuration and activation/indication may use the same RRC signaling or separate RRC signaling. In one embodiment, the mode configuration may include information indicating the two modes that are configured for the UE, e.g., indexes or identifiers of the two modes. In another embodiment, for scheme 1, the mode configuration may be made by configuring an orthogonal cover code (OCC) pattern having a length/size of 4 (corresponding to mode 2) and an OCC pattern having a length of 2 (corresponding to mode 1) for DM-RS communication. In yet another embodiment, for scheme 1, the mode configuration may be made by configuring a frequency domain OCC (FD-OCC) length that is 4 (corresponding to mode 2) and a FD-OCC length that is 2 (corresponding to mode 1). The two different FD-OCC lengths may be indicated by indexes or identifiers associated with the two different lengths, respectively. The UE may thus understand that the two modes are configured for it based on the indicated OCC patterns of different lengths or the indicated different OCC lengths. In this case, the activation may be made by signaling one of the lengths of the OCC patterns (the OCC pattern of length 4 or OCC pattern of length 2), based on which, the UE understands which mode is activated. The OCCs may be indicated, e.g., by the antenna port(s) field in DCI. The embodiments for mode configuration may be applied for methods illustrated in FIG. 16 and FIG. 17. For SU/MU-MIMO, the mode configuration may be configured to each UE specifically and one mode is activated through the high layer RRC signaling. The DM-RS configuration includes information of the Type 1 and/or Type 2 DM-RS configuration(s), a maximum length of OFDM symbols, and so on.

In response to receiving the configuration and activation in step 1502, the UE may send a configuration acknowledge to the gNB (step 1504). The gNB may then schedule a PDSCH for the UE through a DCI message on a PDCCH (step 1506), and transmit the PDSCH accordingly (step 1508). DM-RS corresponding to the PDSCH is also transmitted to the UE. The DCI includes the DM-RS port information. The UE obtains information about the DM-RS ports based on the DCI and the activated mode as discussed above, receives a DM-RS on the obtained DM-RS ports and receives the PDSCH based on the DM-RS. The UE may send PDSCH acknowledgement/negative acknowledgement (ACK/NACK) to the gNB to indicate whether the PDSCH is successfully received (step 1510). Steps 1508 and 1510 may be implemented conventionally.

FIG. 16 is a flowchart of an embodiment method 1600, highlighting configuration of two modes through high layer RRC signaling and activation of one of the two modes by a MAC-CE. The gNB may send a DM-RS configuration, and a mode configuration to the UE through RRC signaling (1602). The mode configuration may configure the two modes of operations under scheme 1, or a mode combination under scheme 2 (e.g., mode 1 and mode 3, or mode 1 and mode 2) for the UE. The mode configuration may directly indicate the two modes, or indicate two OCC patterns of lengths 2 and 4 respectively for scheme 1, or indicate two OCC lengths (e.g., OCC length 2 and OCC length 4), as described above. In response to receiving the configuration in step 1602, the UE may send a configuration acknowledge to the gNB (step 1604). The gNB may activate one of the configured modes through the MAC-CE (step 1606). The MAC-CE may include an index or identifier of the to-be-activated mode; or for scheme 1, may indicate an OCC length 2 or an OCC length 4 as described above. Steps 1608-1612 are similar to steps 1506-1510. The gNB may schedule a PDSCH for the UE through a DCI message on a PDCCH (step 1608), and transmit the PDSCH accordingly (step 1610). The UE receives the PDSCH based on DM-RS over DM-RS ports that are determined based on the DCI message and the activated mode as described above. The UE may send PDSCH ACK/NACK to the gNB (step 1612).

FIG. 17 is a flowchart of an embodiment method 1700, highlighting configuration of two modes through RRC signaling and activation of one of the two modes through a DCI message. In this embodiment, the network may dynamically signal the UE to switch between the two configured modes through the DCI message. As shown, the gNB may send a DM-RS configuration and a mode configuration to the UE through RRC signaling (1702). The mode configuration may configure the two modes of operations under scheme 1, or a mode combination under scheme 2 (e.g., mode 1 and mode 3, or mode 1 and mode 2) for the UE. The mode configuration may directly indicate the two modes, or indicate two OCC patterns of lengths 2 and 4 for scheme 1, or indicated two OCC lengths (e.g., OCC length 2 and OCC length 4), as described above. In response to receiving the configuration in step 1702, the UE may send a configuration acknowledge to the gNB (step 1704). The gNB may activate one of the configured modes through the DCI message. The DCI message may include an index or identifier of the to-be-activated mode; or for scheme 1, may indicate an OCC length 2 or an OCC length 4 as described above. If the UE is already in one mode, the DCI message serves as an instruction to switch the UE to the activated mode. In one embodiment, the gNB may schedule a PDSCH for the UE through a DCI message on a PDCCH, and also activate one of the two modes through the DCI message (step 1706). The gNB transmits the PDSCH (step 1708), and the UE receives the PDSCH based on DM-RS over DM-RS ports that are determined based on the DCI message and the activated mode as described above. The UE may send PDSCH ACK/NACK to the gNB indicating whether the PDSCH is successfully received (step 1710).

Scheme 1 or scheme 2 fulfill the objective of doubling the number of orthogonal DM-RS ports without increasing DM-RS resource overhead. For scheme 1, the time duration of cyclic shifts in the time domain to accommodate UE channel impulse response is halved. In the case of MU-MIMO having several UEs with long path propagation delays, mutual interference from the channel impulse response between the cyclic shifts may cause extra DM-RS channel estimation errors, and may degrade system MU-MIMO performance. For scheme 2, the effective time window duration without overlap for each comb is halved, and for UEs with long path propagation delays, extra DM-RS channel estimation errors may degrade system performance as a result of impulse response partial overlap and interference.

### Embodiments for Type-2 DM-RS Configuration

For the legacy Type-2 DM-RS configuration, a frequency domain OCC of length 2 over adjacent 2 REs and frequency division multiplexing (FDM) are used to support 6 orthogonal DM-RS ports when 1 OFDM symbol is configured (as shown in FIG. 4). When 2 OFDM symbols are configured for the legacy Type-2 DM-RS configuration, the time domain OCC of length 2 is further used to generate orthogonal DM-RS ports, which gives a total of 12 orthogonal ports (as shown in FIG. 5). With more orthogonal ports added, the Type-2 configuration can potentially provide high system throughput for massive MIMO where a larger number of data streams of MU-MIMO is desired. Type-2 DM-RS may only be configured for CP-OFDM PDSCH and PUSCH by RRC configuration.

In some embodiments, to provide additional DM-RS ports for the Type-2 configuration, the 6 pairs of adjacent 2 REs in a resource block may all be used to support different orthogonal ports. With the use of a frequency domain OCC of length2 over each pair of adjacent RES, 12 orthogonal DM-RS ports may be supported for the single OFDM symbol configuration. For the double OFDM symbols configuration, the same legacy time domain OCC of length2, {[+1+1], [+1−1]}, may further be used to double the orthogonal DM-RS ports, giving a total of 24 orthogonal DM-RS ports in the frequency domain.

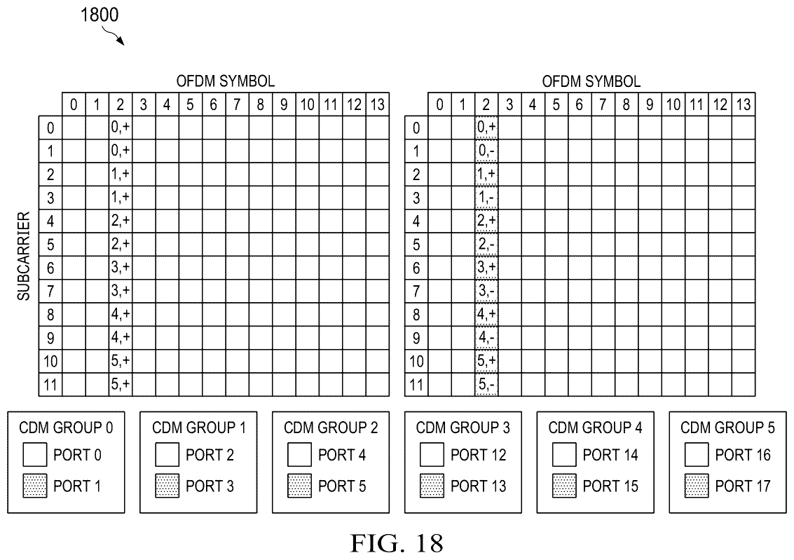

FIG. 18 is a diagram 1800 showing an embodiment configuration of doubling the DM-RS ports of the Type-2 configuration with one symbol configured. In this example, additional 6 ports 12-17 are provided, giving 12 ports in total. The resources in the frequency domain for each port are halved. The embodiment configuration also provides three new CDM groups of indexes 3, 4 and 5, which are not supported by the legacy Type-2 configuration (including CDM groups 0, 1, 2). In this example, ports 12 and 13 are defined to belong to CDM group 3, ports 14 and 15 belong to CDM group 4, and port 16 and 17 belong to CDM group 5.

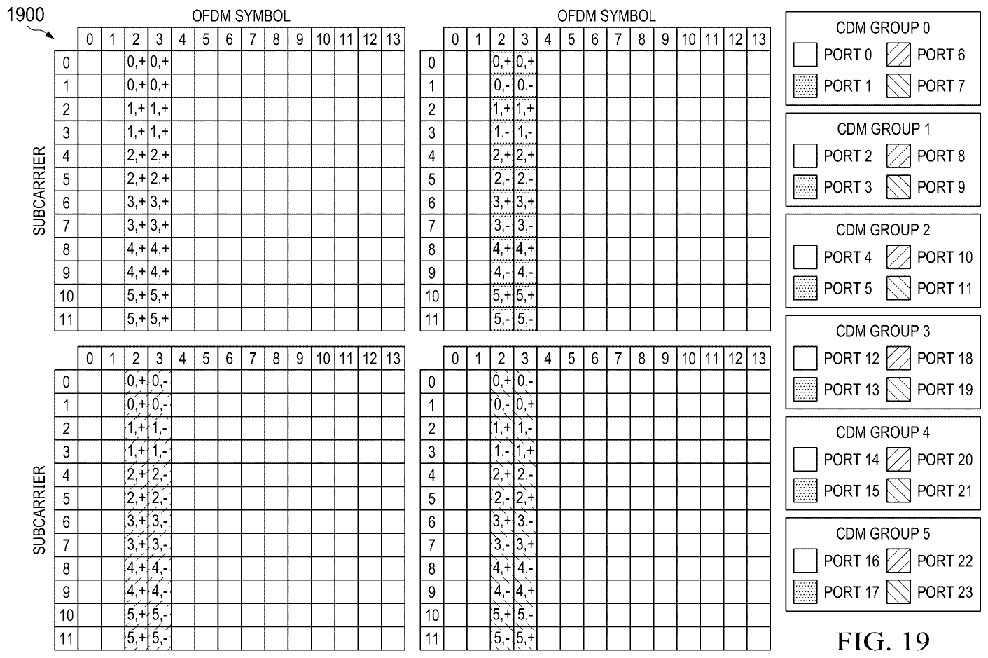

FIG. 19 is a diagram 1900 showing an embodiment configuration of doubling the DM-RS ports of the Type-2 configuration with two symbols configured. The resources in the frequency domain for each port are halved. The embodiment configuration provides additional 12 ports 12-23, and three new CDM groups with indexes 3, 4 and 5, which are not supported by the legacy Type-2 configuration (including CDM groups 0, 1, 2). In this example, ports 12, 13, 18 and 19 are defined to belong to CDM group 3, ports 14, 15, 20 and 21 belong to CDM group 4, and ports 16, 17, 22 and 23 belong to CDM group 5.

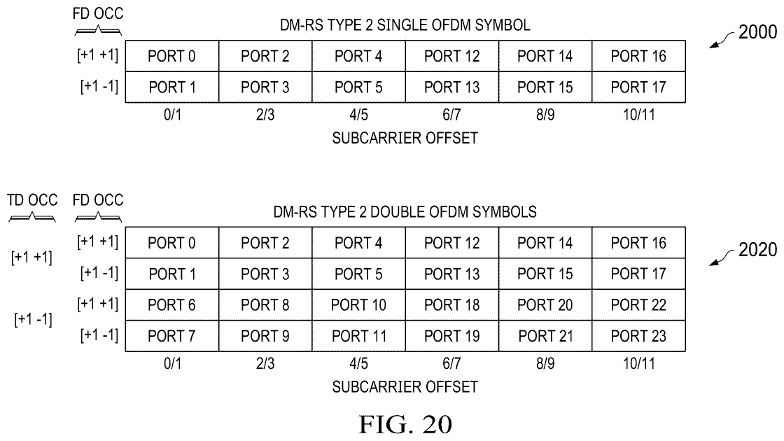

FIG. 20 shows example relative subcarrier locations of the DM-RS ports in FIG. 18 and FIG. 19. FIG. 20 includes a table 2000 showing the relative subcarrier locations of the DM-RS ports of FIG. 18. OCC patterns of length 2 are applied respectively in the frequency domain. FIG. 20 also includes a table 2020 showing the relative subcarrier locations of the DM-RS ports of FIG. 19. As shown, in addition to the two OCCs of length 2 applied in the frequency domain, the same legacy time domain OCC of length 2, {[+1+1], [+1−1]}, is also applied in the time domain.

In some embodiments, to map the DM-RS sequence to the resource elements for the additional DM-RS ports, based on the modified equations from Section 7.4.1.1.2 in TS 38.211, a UE may assume the mapping according to:

$${α}_{k , l}^{( p , u )} = {β}_{PDSCH}^{DMRS} {w}_{f} ( {k}^{′} ) {w}_{t} ( {l}^{′} ) r ( 2 n + {k}^{′} )$$

$$k = 12 n + 2 {k}^{′} + Δ Configuration type 1$$

$${k}^{′} = 0 , 1$$

$$l = \overline{l} + {l}^{′}$$

$$n = 0 , 1 …$$

where wₜ(l′) and the time domain related parameters, l̅ and l′, are defined in the same way and are given by Tables 7.4.1.1.2-1, 7.4.1.1.2-2, 7.4.1.1.2-3, 7.4.1.1.2-4 and 7.4.1.1.2-5 in 5G NR TS 38.211 specification. r(n) is defined in section 7.4.1.1.1 of 5G NR TS 38.211 specification. w_{f}(k′) is given in table 7.4.1.1.2-1 of TS 38.212. Table 6 below shows example parameters used for the mapping. The table is obtained by modifying the Table 7.4.1.1.2-1 in TS 38.211.

TABLE 6

| | CDM | | w_{f} (k′) | |
|---|---|---|---|---|
| p | group λ | Δ | k′ = 0 | k′ = 1 |
| 1000 | 0 | 0 | +1 | +1 |
| 1001 | 0 | 0 | +1 | −1 |
| 1002 | 1 | 2 | +1 | +1 |
| 1003 | 1 | 2 | +1 | −1 |
| 1004 | 2 | 4 | +1 | +1 |
| 1005 | 2 | 4 | +1 | −1 |
| 1006 | 0 | 0 | +1 | +1 |
| 1007 | 0 | 0 | +1 | −1 |
| 1008 | 1 | 2 | +1 | +1 |
| 1009 | 1 | 2 | +1 | −1 |
| 1010 | 2 | 4 | +1 | +1 |
| 1011 | 2 | 4 | +1 | −1 |
| 1012 | 3 | 6 | +1 | +1 |
| 1013 | 3 | 6 | +1 | −1 |
| 1014 | 4 | 8 | +1 | +1 |
| 1015 | 4 | 8 | +1 | −1 |
| 1016 | 5 | 10 | +1 | +1 |
| 1017 | 5 | 10 | +1 | −1 |
| 1018 | 3 | 6 | +1 | +1 |
| 1019 | 3 | 6 | +1 | −1 |
| 1020 | 4 | 8 | +1 | +1 |
| 1021 | 4 | 8 | +1 | −1 |
| 1022 | 5 | 10 | +1 | +1 |
| 1023 | 5 | 10 | +1 | −1 |

Similarly, the design of port indexing, grouping, and signaling needs to consider backward compatibility with legacy DM-RS ports definition as much as possible. The design may also need to avoid redesigning of port indexing, grouping, and signaling completely. When the purpose of adding additional DR-MS ports in Rel. 18 is solely targeting MU-MIMO instead of SU-MIMO scenarios, legacy DM-RS port indexing, grouping, and signaling may be reused as much as possible.

For the SU-MIMO scenario, the design for the legacy DM-RS ports may be reused. A UE may be scheduled with a few DM-RS ports by the antenna port index(es) in DCI format 1_1 as described in Clause 7.3.1.2 of [5, TS 38.212].

TS 38.212 specifies that, for DM-RS configuration type 2,
if a UE is scheduled with one codeword and assigned with the antenna port mapping with indices of {2, 10 or 23} in Table 7.3.1.2.2-3 and Table 7.3.1.2.2-4 of Clause 7.3.1.2 of [5, TS38.212], or
if a UE is scheduled with one codeword and assigned with the antenna port mapping with indices of {2, 10, 23 or 24} in Table 7.3.1.2.2-3A and {2, 10, 23 or 58} in Table 7.3.1.2.2-4A of Clause 7.3.1.2 of [5, TS 38.212], or
if a UE is scheduled with two codewords,
   the UE may assume that all the remaining orthogonal antenna ports are not associated with transmission of PDSCH to another UE.

For the SU/MU-MIMO scenario and the DM-RS configuration type 2, a UE may be configured with three modes of operation for DM-RS port(s) indication, as described in the following.

### Mode 1: Legacy DM-RS CDM Port(s)

In this mode of operation, a DCI message is transmitted and interpreted in the same way as described in Section 7.3.1.2.2 of TS 38.212 and Section 5.1.6.2 of TS 38.214. The definitions of DM-RS ports follow the legacy DM-RS ports definitions. The usage for this mode may be for targeting better handling of longer propagation path delay or backward compatible with legacy UEs.

### Mode 2: Double DM-RS CDM Ports and Double CDM Groups Without Data

In this mode of operation, the number of DM-RS CDM ports doubles and the frequency density of each DM-RS CDM port is halved. The number of DM-RS CDM groups without data is also doubled based on the scheduled number of DM-RS CDM groups without data. This mode may be used for multiplexing more UE transmission simultaneously.

### Mode 3: Double DM-RS CDM Ports Only

In this mode of operation, the number of DM-RS CDM ports doubles and the frequency density of each DM-RS CDM port is halved. The number of DM-RS CDM groups without data is not doubled and is the same as the scheduled number of DM-RS CDM groups without data. This mode may be used for providing high spectrum efficiency and reducing UE DM-RS overlapping in the frequency domain from different transmitters.

To indicate the additional DM-RS ports for mode 2 and 3, in some embodiments, a new bit may be defined in addition to the legacy DCI message, or a bit in the legacy DCI message may be defined with new definition. This bit is referred to as a DM-RS port offset bit. In one embodiment, the bit may be designed as follows:
If the DM-RS port offset bit is 0, no port offset shall be added;
If the DM-RS port offset bit is 1, add 12 to the port index(es) of a corresponding entry in a corresponding lookup table (e.g., Tables 7.3.1.2.2-3, 7.3.1.2.2-3A, 7.3.1.2.2-4, or 7.3.1.2.2-4A in TS 38.212).
Alternatively, the bit value of the DM-RS port offset bit being 1 indicates that no port offset shall be added, and the bit value of the DM-RS port offset bit being o indicates adding 12 to the port index(es).

For DM-RS type 2 with doubled ports, the maximum number of DM-RS CDM groups without data is increased from 3 to 6. The indication of the number of DM-RS CDM group(s) without data also changes accordingly. Mode 2 and mode 3 are configured to handle this situation differently.

For mode 2, the network schedules multiple UEs for simultaneous transmission. In an embodiment, a UE may determine the number of CDM group(s) without data and the DM-RS ports as described in the following, which is referred to as mode 2 approach. The UE may derive DM-RS port(s) transmission information according to the antenna port(s) bits and the DM-RS port offset bit indicated in received DCI signaling. The UE may search a lookup table and read the entry corresponding to the received antenna port(s) bits. The UE may derive the number of CDM group(s) without data by doubling the corresponding number of CDM group(s) without data in the entry. The additional DM-RS CDM group index(es) without data may be obtained by adding 3 to the index(es) in the entry.

For example, if the configuration of DM-RS is type 2 and the maximum length of OFDM symbols is 2, then Table 7.3.1.2.2-4 in 38.212 (Table 7 below) may be used for table lookup. In this example, one codeword is enabled and the antenna port(s) bits have a value 45. From the entry corresponding to value 45 in the lookup table (Table 7), the indicated DM-RS ports are 0,1,6,7, and the number of DM-RS CDM groups without data is 3, i.e., 3DM-RS CDM groups with indexes {0,1,2}. Then the UE doubles the number of 3 to get a new number of DM-RS CDM groups without data, which is 6. The UE may add 3 to {0,1,2} to obtain 3 new indexes of DM-RS CDM group without data, i.e., {3,4,5}, and combine it with {0,1,2} to get the indexes of the final DM-RS CDM groups without data, i.e., {0,1,2,3,4,5}. If the DM-RS port offset bit is 0, the UE shall expect the DM-RS transmission on ports 0,1,6,7.If DM-RS port offset bit is 1, the UE shall add 12 to {0,1,6,7}, and expect the DM-RS transmission on ports 12,13,18,19.

For another example, if the configuration of DM-RS is type 2 and the maximum length of OFDM symbols is 2, then Table 7.3.1.2.2-4 in 38.212 (Table 7) may be used for table lookup. In this example, one codeword is enabled and the antenna port(s) bits have a value 7. From the entry corresponding to value 7 in the lookup table, the indicated DM-RS ports are 0,1 and the number of DM-RS CDM groups without data is 2, i.e., two DM-RS CDM groups with indexes {0,1}. Then the UE shall double the number of 2 to get a new number of DM-RS CDM groups without data, which is 4. The UE may add 3 to {0,1} (resulted in {3,4}) and combines with {0,1} to get the indexes of the final DM-RS CDM groups without data, {0,1,3,4}. If the DM-RS port offset bit is 0, the UE shall expect the DM-RS transmission on ports 0,1. If the DM-RS port offset bit is 1, the UE shall add 12 to {0,1} and expect the DM-RS transmission on ports 12, 13.

TABLE 7
Table 7.3.1.2.2-4: Antenna port(s) (1000 + DMRS port),
dmrs-Type = 2, maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of DMRS | | Number | | of DMRS | | Number |
| | CDM | | of | | CDM | | of |
| | group(s) | | front- | | group(s) | | front- |
| | without | DMRS | load | | without | DMRS | load |
| Value | data | port(s) | symbols | Value | data | port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, 2, 3, 6 | 2 |
| 3 | 2 | 0 | 1 | 3 | 2 | 0, 1, 2, 3, 6, 8 | 2 |
| 4 | 2 | 1 | 1 | 4 | 2 | 0, 1, 2, 3, 6, | 2 |
| | | | | | | 7, 8 | |
| 5 | 2 | 2 | 1 | 5 | 2 | 0, 1, 3, 6, 7, | 2 |
| | | | | | | 8, 9 | |
| 6 | 2 | 3 | 1 | 6-63 | Reserved | Reserved | Reserved |
| 7 | 2 | 0, 1 | 1 | | | | |
| 8 | 2 | 2, 3 | 1 | | | | |
| 10 | 2 | 0-3 | 1 | | | | |
| 11 | 3 | 0 | 1 | | | | |
| 12 | 3 | 1 | 1 | | | | |
| 13 | 3 | 2 | 1 | | | | |
| 14 | 3 | 3 | 1 | | | | |
| 15 | 3 | 4 | 1 | | | | |
| 16 | 3 | 5 | 1 | | | | |
| 17 | 3 | 0, 1 | 1 | | | | |
| 18 | 3 | 2, 3 | 1 | | | | |
| 19 | 3 | 4, 5 | 1 | | | | |
| 20 | 3 | 0-2 | 1 | | | | |
| 21 | 3 | 3-5 | 1 | | | | |
| 22 | 3 | 0-3 | 1 | | | | |
| 23 | 2 | 0, 2 | 1 | | | | |
| 24 | 3 | 0 | 2 | | | | |
| 25 | 3 | 1 | 2 | | | | |
| 26 | 3 | 2 | 2 | | | | |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, 6, 7 | 2 | | | | |
| 46 | 3 | 2, 3, 8, 9 | 2 | | | | |
| 47 | 3 | 4, 5, 10, 11 | 2 | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |

In some embodiments, if the DM-RS port offset bit is 0, the UE may read the DM-RS port(s) index(es) and the number of DM-RS CDM group(s) without data directly from a new lookup table, e.g., Table 8 below, which is obtained by modifying Table 7.3.1.2.2-4. If the DM-RS port offset bit is 1, the UE may read the DM-RS port(s) index(es) and the number of DM-RS CDM group(s) without data directly from another new lookup, e.g., Table 9 below which is obtained by modifying Table 7.3.1.2.2-4. Table 7.3.1.2.2-3, 7.3.1.2.2-3A and 7.3.1.2.2-4A may be modified in the similar way.

TABLE 8

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of DMRS | | Number | | of DMRS | | Number |
| | CDM | | of | | CDM | | of |
| | group(s) | | front- | | group(s) | | front- |
| | without | DMRS | load | | without | DMRS | load |
| Value | data | port(s) | symbols | Value | data | port(s) | symbols |
| 0 | 2 | 0 | 1 | 0 | 3 | 0-4 | 1 |
| 1 | 2 | 1 | 1 | 1 | 3 | 0-5 | 1 |
| 2 | 1 | 0, 1 | 1 | 2 | 2 | 0, 1, 2, 3, 6 | 2 |
| 3 | 4 | 0 | 1 | 3 | 2 | 0, 1, 2, 3, 6, 8 | 2 |
| 4 | 4 | 1 | 1 | 4 | 2 | 0, 1, 2, 3, 6, | 2 |
| | | | | | | 7, 8 | |
| 5 | 4 | 2 | 1 | 5 | 2 | 0, 1, 3, 6, 7, | 2 |
| | | | | | | 8, 9 | |
| 6 | 4 | 3 | 1 | 6-63 | Reserved | Reserved | Reserved |
| 7 | 4 | 0, 1 | 1 | | | | |
| 8 | 2 | 2, 3 | 1 | | | | |
| 9 | 4 | 0-2 | 1 | | | | |
| 10 | 2 | 0-3 | 1 | | | | |
| 11 | 6 | 0 | 1 | | | | |
| 12 | 6 | 1 | 1 | | | | |
| 13 | 6 | 2 | 1 | | | | |
| 14 | 6 | 3 | 1 | | | | |
| 15 | 6 | 4 | 1 | | | | |
| 16 | 6 | 5 | 1 | | | | |
| 17 | 6 | 0, 1 | 1 | | | | |
| 18 | 6 | 2, 3 | 1 | | | | |
| 19 | 6 | 4, 5 | 1 | | | | |
| 20 | 3 | 0-2 | 1 | | | | |
| 21 | 3 | 3-5 | 1 | | | | |
| 22 | 6 | 0-3 | 1 | | | | |
| 23 | 2 | 0, 2 | 1 | | | | |
| 24 | 6 | 0 | 2 | | | | |
| 25 | 6 | 1 | 2 | | | | |
| 26 | 6 | 2 | 2 | | | | |
| 27 | 6 | 3 | 2 | | | | |
| 28 | 6 | 4 | 2 | | | | |
| 29 | 6 | 5 | 2 | | | | |
| 30 | 6 | 6 | 2 | | | | |
| 31 | 6 | 7 | 2 | | | | |
| 32 | 6 | 8 | 2 | | | | |
| 33 | 6 | 9 | 2 | | | | |
| 34 | 6 | 10 | 2 | | | | |
| 35 | 6 | 11 | 2 | | | | |
| 36 | 6 | 0, 1 | 2 | | | | |
| 37 | 6 | 2, 3 | 2 | | | | |
| 38 | 6 | 4, 5 | 2 | | | | |
| 39 | 6 | 6, 7 | 2 | | | | |
| 40 | 6 | 8, 9 | 2 | | | | |
| 41 | 6 | 10, 11 | 2 | | | | |
| 42 | 6 | 0, 1, 6 | 2 | | | | |
| 43 | 6 | 2, 3, 8 | 2 | | | | |
| 44 | 6 | 4, 5, 10 | 2 | | | | |
| 45 | 6 | 0, 1, 6, 7 | 2 | | | | |
| 46 | 6 | 2, 3, 8, 9 | 2 | | | | |
| 47 | 6 | 4, 5, 10, 11 | 2 | | | | |
| 48 | 2 | 0 | 2 | | | | |
| 49 | 2 | 1 | 2 | | | | |
| 50 | 2 | 6 | 2 | | | | |
| 51 | 2 | 7 | 2 | | | | |
| 52 | 2 | 0, 1 | 2 | | | | |
| 53 | 2 | 6, 7 | 2 | | | | |
| 54 | 4 | 0, 1 | 2 | | | | |
| 55 | 4 | 2, 3 | 2 | | | | |
| 56 | 4 | 6, 7 | 2 | | | | |

TABLE 9

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of DMRS | | Number | | of DMRS | | Number |
| | CDM | | of | | CDM | | of |
| | group(s) | | front- | | group(s) | | front- |
| | without | DMRS | load | | without | DMRS | load |
| Value | data | port(s) | symbols | Value | data | port(s) | symbols |
| 0 | 2 | 12 | 1 | 0 | 3 | 0-4 | 1 |
| 1 | 2 | 13 | 1 | 1 | 3 | 0-5 | 1 |
| 2 | 1 | 0, 1 | 1 | 2 | 2 | 0, 1, 2, 3, 6 | 2 |
| 3 | 4 | 12 | 1 | 3 | 2 | 0, 1, 2, 3, 6, 8 | 2 |
| 4 | 4 | 13 | 1 | 4 | 2 | 0, 1, 2, 3, 6, | 2 |
| | | | | | | 7, 8 | |
| 5 | 4 | 14 | 1 | 5 | 2 | 0, 1, 2, 3, 6, | 2 |
| | | | | | | 7, 8, 9 | |
| 6 | 4 | 15 | 1 | 6-63 | Reserved | Reserved | Reserved |
| 7 | 4 | 12, 13 | 1 | | | | |
| 8 | 4 | 14, 15 | 1 | | | | |
| 9 | 4 | 12-14 | 1 | | | | |
| 10 | 2 | 0-3 | 1 | | | | |
| 11 | 6 | 12 | 1 | | | | |
| 12 | 6 | 13 | 1 | | | | |
| 13 | 6 | 14 | 1 | | | | |
| 14 | 6 | 15 | 1 | | | | |
| 15 | 6 | 16 | 1 | | | | |
| 16 | 6 | 17 | 1 | | | | |
| 17 | 6 | 12, 13 | 1 | | | | |
| 18 | 6 | 14, 15 | 1 | | | | |
| 19 | 6 | 16, 17 | 1 | | | | |
| 20 | 6 | 12-14 | 1 | | | | |
| 21 | 6 | 15-17 | 1 | | | | |
| 22 | 6 | 12-15 | 1 | | | | |
| 23 | 2 | 0, 2 | 1 | | | | |
| 24 | 6 | 12 | 2 | | | | |
| 25 | 6 | 13 | 2 | | | | |
| 26 | 6 | 14 | 2 | | | | |
| 27 | 6 | 15 | 2 | | | | |
| 28 | 6 | 16 | 2 | | | | |
| 29 | 6 | 17 | 2 | | | | |
| 30 | 6 | 18 | 2 | | | | |
| 31 | 6 | 19 | 2 | | | | |
| 32 | 6 | 20 | 2 | | | | |
| 33 | 6 | 21 | 2 | | | | |
| 34 | 6 | 22 | 2 | | | | |
| 35 | 6 | 23 | 2 | | | | |
| 36 | 6 | 12, 13 | 2 | | | | |
| 37 | 6 | 14, 15 | 2 | | | | |
| 38 | 6 | 16, 17 | 2 | | | | |
| 39 | 6 | 18, 19 | 2 | | | | |
| 40 | 6 | 20, 21 | 2 | | | | |
| 41 | 6 | 22, 23 | 2 | | | | |
| 42 | 6 | 12, 13, 18 | 2 | | | | |
| 43 | 6 | 14, 15, 20 | 2 | | | | |
| 44 | 6 | 16, 17, 22 | 2 | | | | |
| 45 | 6 | 12, 13, 18, 19 | 2 | | | | |
| 46 | 6 | 14, 15, 20, 21 | 2 | | | | |
| 47 | 6 | 16, 17, 22, 23 | 2 | | | | |
| 48 | 2 | 12 | 2 | | | | |
| 49 | 2 | 13 | 2 | | | | |
| 50 | 2 | 18 | 2 | | | | |
| 51 | 2 | 19 | 2 | | | | |
| 52 | 2 | 12, 13 | 2 | | | | |
| 53 | 2 | 18, 19 | 2 | | | | |
| 54 | 4 | 12, 13 | 2 | | | | |
| 55 | 4 | 14, 15 | 2 | | | | |
| 56 | 4 | 18, 19 | 2 | | | | |

For mode 3, the network schedules multiple UEs for simultaneous transmission. In some embodiments, a UE may determine the number of CDM group(s) without data and the DM-RS ports as described in the following, which is referred to as mode 3 approach. The UE may derive DM-RS port(s) transmission information according to antenna port(s) bits and the DM-RS port offset bit indicated/included in received DCI signaling. The UE may search the lookup table and read the entry corresponding to the received antenna port(s) bits. If the DM-RS port offset bit is 0, the DM-RS CDM group index(es) without data is the same as that of the entry. If the DM-RS port offset bit is 1, the DM-RS CDM group index(es) without data may be derived by adding 3 to index(es) in the entry.

For example, if the configuration of DM-RS is type 2 and the maximum length of OFDM symbols is 1, then table 7.3.1.2.2-3 in 38.212 (Table 10 below) may be used for table lookup. In this example, one codeword is enabled and the antenna port(s) bits have a value 8. From the entry corresponding to value 8 in the lookup table, the indicated DM-RS ports are 2,3 and the number of DM-RS CDM groups without data is 2, i.e., two DM-RS CDM groups indexed with {0,1}. If the DM-RS port offset bit is 0, the UE may derive the indexes of the DM-RS CDM groups without data directly from the indicated value {0,1} and shall expect the DM-RS transmission on ports 2,3. If the DM-RS port offset bit is 1, UE adds 3 to {0,1} to get indexes of the final DM-RS CDM groups without data, i.e., {3,4}, and shall expect the DM-RS transmission on ports 14,15 (i.e., port 2,3 +12=port 14,15).

TABLE 10
Table 73.1.2.2-3: Antenna port(s) (1000 + DMRS
port), dmrs-Type = 2, maxLength = 1

| One codeword: | | | Two codewords: | | |
|---|---|---|---|---|---|
| Codeword 0 enabled, | | | Codeword 0 enabled, | | |
| Codeword 1 disabled | | | Codeword 1 enabled | | |
| | Number | | | Number | |
| | of DMRS | | | of DMRS | |
| | CDM | | | CDM | |
| | group(s) | | | group(s) | |
| | without | DMRS | | without | DMRS |
| Value | data | port(s) | Value | data | port(s) |
| 0 | 1 | 0 | 0 | 3 | 0-4 |
| 1 | 1 | 1 | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24-31 | Reserved | Reserved | | | |

In some embodiments, if the DM-RS port offset bit is 1, the UE may read the DM-RS port(s) index(es) and the number of DM-RS CDM group(s) without data directly from a new lookup table x, e.g., Table 11 below, which is obtained by modifying Table 7.3.1.2.2-3. Table 7.3.1.2.2-34, 7.3.1.2.2-4 and 7.3.1.2.2-4A may be modified in the similar way.

TABLE 11

| One codeword: | | | Two codewords: | | |
|---|---|---|---|---|---|
| Codeword 0 enabled, | | | Codeword 0 enabled, | | |
| Codeword 1 disabled | | | Codeword 1 enabled | | |
| | Number | | | Number | |
| | of DMRS | | | of DMRS | |
| | CDM | | | CDM | |
| | group(s) | | | group(s) | |
| | without | DMRS | | without | DMRS |
| Value | data | port(s) | Value | data | port(s) |
| 0 | 1 | 12 | 0 | 3 | 0-4 |
| 1 | 1 | 13 | 1 | 3 | 0-5 |
| 2 | 1 | 0, 1 | 2-31 | reserved | reserved |
| 3 | 2 | 12 | | | |
| 4 | 2 | 13 | | | |
| 5 | 2 | 14 | | | |
| 6 | 2 | 15 | | | |
| 7 | 2 | 12, 13 | | | |
| 8 | 2 | 14, 15 | | | |
| 9 | 2 | 12-14 | | | |
| 10 | 2 | 0-3 | | | |
| 11 | 3 | 12 | | | |
| 12 | 3 | 13 | | | |
| 13 | 3 | 14 | | | |
| 14 | 3 | 15 | | | |
| 15 | 3 | 16 | | | |
| 16 | 3 | 17 | | | |
| 17 | 3 | 12, 13 | | | |
| 18 | 3 | 14, 15 | | | |
| 19 | 3 | 16, 17 | | | |
| 20 | 3 | 12-14 | | | |
| 21 | 3 | 15-17 | | | |
| 22 | 3 | 12-15 | | | |
| 23 | 2 | 0, 2 | | | |
| 24-31 | Reserved | Reserved | | | |

In one embodiment, one of the three modes of operations may be configured to each UE specifically, and activated through high layer RRC signaling. In another embodiment, one of mode combinations, e.g., a combination of modes 1 and 2, or modes 1 and 3, may be configured to each UE through high layer RRC signaling, and one mode of the configured mode combination may be activated by RRC signaling, a MAC-CE or DCI.

In some embodiments, the network may signal a UE to switch between the two modes dynamically within the configured mode combination, i.e., modes 1 and 2, or modes 1 and 3, by defining a new bit in addition to the legacy DCI message, or defining a bit in the legacy DCI message with new definition. This bit may be referred to as a DM-RS operation mode bit, as described above with respect to the Type-1 configuration.

When the bit is configured for the mode combination of modes 1 and 2, the bit may be defined as follows:
if the DM-RS operation mode bit is 1, the UE shall operate in mode 1;
if the DM-RS operation mode bit is 0, the UE shall operate in mode 2;
or, alternatively, if the DM-RS operation mode bit is 0, the UE shall operate in mode 1; and if the DM-RS operation mode bit is 1, the UE shall operate in mode 2.

When the bit is configured for the mode combination of modes 1 and 3, the bit may be defined as follows:
if the DM-RS operation mode bit is 1, the UE shall operate in mode 1;
if the DM-RS operation mode bit is 0, the UE shall operate in mode 3;
or, alternatively, if the DM-RS operation mode bit is 0, the UE shall operate in mode 1; and if the DM-RS operation mode bit is 1, the UE shall operate in mode 3.

As an example, assuming that the configuration of DM-RS is type 2 and the maximum length of OFDM symbols is 1, Table 7.3.1.2.2-3 in TS 38.212 (e.g., Table 10 above) may be used for table lookup. In this example, 4 UEs are scheduled for MU-MIMO transmission, and the network may signal a mode to each UE. Each UE determines the DM-RS ports based on the signaling from the network as follows:
UE1 is signaled to operate in mode 2, and signaled with antenna port bits value 14 and DM-RS port offset bit value 0. UE1 shall expect DM-RS transmission on port 3 and DM-RS CDM groups without data indexes {0,1,2,3,4,5} according to the mode 2 approach.
UE2 is signaled to operate in mode 2, and signaled with antenna port bits value 14 and DM-RS port offset bit value 1. UE2 shall expect DM-RS transmission on port 15 (port 3+12) and DM-RS CDM groups without data indexes {0,1,2,3,4,5} according to the mode 2 approach.
UE3 is signaled to operate in mode 2, and signaled with antenna port bits value 15 and DM-RS port offset bit value 0. UE3 shall expect DM-RS transmission on port 4 and DM-RS CDM groups without data indexes {0,1,2,3,4,5} according to the mode 2 approach.
UE4 is signaled to operate in mode 1, and signaled with antenna port bits value 17 and DM-RS port offset bit value 0. UE4 shall expect DM-RS transmission on ports 0,1 and DM-RS CDM groups without data indexes {0,1,2} of the legacy DM-RS ports definition.

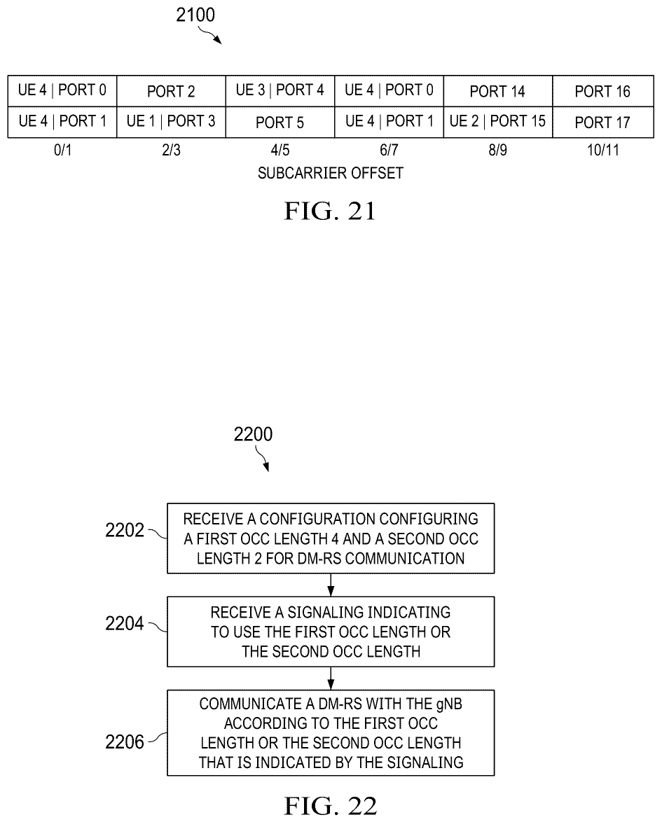

FIG. 21 is a diagram 2100 showing an embodiment DM-RS ports assignment in the frequency domain for UE1-UE4 of the above example.

The embodiment methods described in FIGS. 15-17 may also be applied for mode configuration and activation of the three modes under the Type-2 configuration.

FIG. 22 is a flowchart of an embodiment method 2200 for DM-RS communication. The method 2200 may be indicative of operations performed by a user equipment (UE). As shown, the UE may receive, from a gNB, a configuration configuring a first orthogonal cover code (OCC) length 4 and a second OCC length 2 for demodulation reference signal (DM-RS) communication between the gNB and the UE (step 2202). The UE may receive from the gNB a signaling indicating the UE to use the first OCC length or the second OCC length for the DM-RS communication (step 2204). The UE may then communicate a DM-RS with the gNB according to the first OCC length or the second OCC length that is indicated by the signaling (step 2206).

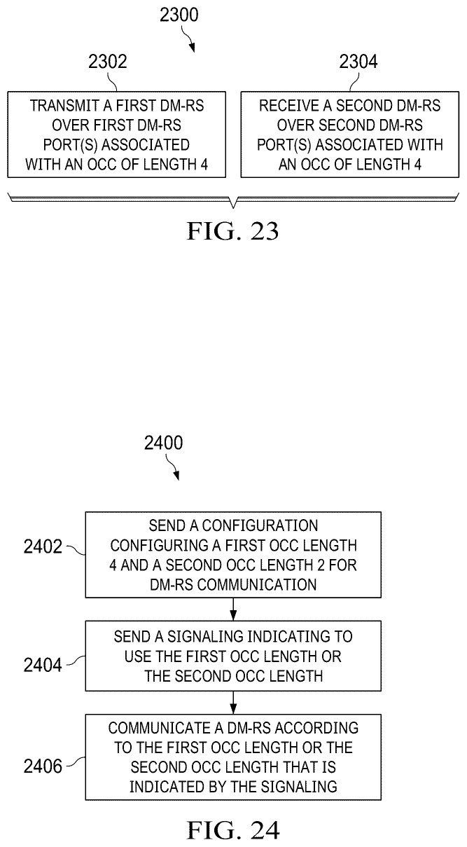

FIG. 23 is a flowchart of another embodiment method 2300 for DM-RS communication. As shown, a communication device may transmit a first demodulation reference signal (DM-RS) over first DM-RS port(s) associated with a orthogonal cover code (OCC) of length 4 (step 2302); or the communication device may receive a second DM-RS over second DM-RS port(s) associated with an OCC of length 4 (step 2304). The communication device may be a UE, or a network device, e.g., a gNB or an access point. The OCC may be [+1+1+1+1], [+1−1+1−1], [+1+j−1−j], or [+1−j−1+j].

FIG. 24 is a flowchart of another embodiment method 2400 for DM-RS communication. The method 2400 may be indicative of operations performed by a network device, e.g., a gNB. As shown, the gNB may send, to a UE, a configuration configuring a first orthogonal cover code (OCC) length 4 and a second OCC length 2 for demodulation reference signal (DM-RS) communications between the gNB and the UE (step 2402). The gNB may send, to the UE, a signaling indicating the UE to communicate according to the first OCC length or the second OCC length (step 2404). The gNB may communicate, with the UE, a DM-RS according to the first OCC length or the second OCC length that is indicated by the signaling (step 2406).

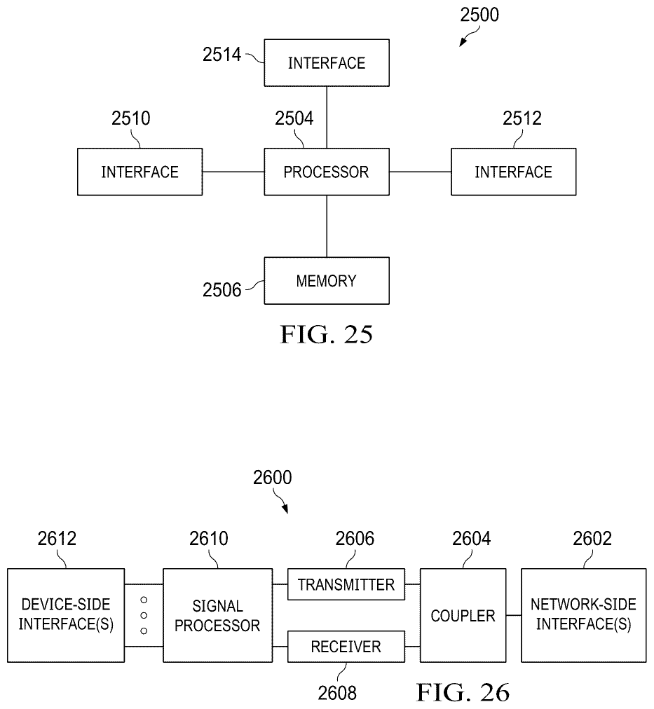

Embodiments of the present disclosure may be implemented as computer-implemented methods. The embodiments may be performed by a processing system. FIG. 25 illustrates a block diagram of an embodiment processing system 2500 for performing methods described herein, which may be installed in a host device. As shown, the processing system 2500 includes a processor 2504, a memory 2506, and interfaces 2510-2514, which may (or may not) be arranged as shown in FIG. 25. The processor 2504 may be any component or collection of components adapted to perform computations and/or other processing related tasks, and the memory 2506 may be any component or collection of components adapted to store programming and/or instructions for execution by the processor 2504. In an embodiment, the memory 2506 includes a non-transitory computer readable medium. The interfaces 2510, 2512, 2514 may be any component or collection of components that allow the processing system 2500 to communicate with other devices/components and/or a user. For example, one or more of the interfaces 2510, 2512, 2514 may be adapted to communicate data, control, or management messages from the processor 2504 to applications installed on the host device and/or a remote device. As another example, one or more of the interfaces 2510, 2512, 2514 may be adapted to allow a user or user device (e.g., personal computer (PC), etc.) to interact/communicate with the processing system 2500. The processing system 2500 may include additional components not depicted in FIG. 25, such as long term storage (e.g., non-volatile memory, etc.).

In some embodiments, the processing system 2500 is included in a network device that is accessing, or part otherwise of, a telecommunications network. In one example, the processing system 2500 is in a network-side device in a wireless or wireline telecommunications network, such as a base station, a relay station, a scheduler, a controller, a gateway, a router, an applications server, or any other device in the telecommunications network. In other embodiments, the processing system 2500 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network. In some embodiments, one or more of the interfaces 2510, 2512, 2514 connects the processing system 2500 to a transceiver adapted to transmit and receive signaling over the telecommunications network.

FIG. 26 illustrates a block diagram of a transceiver 2600 adapted to transmit and receive signaling over a telecommunications network. The transceiver 2600 may be installed in a host device. As shown, the transceiver 2600 comprises a network-side interface 2602, a coupler 2604, a transmitter 2606, a receiver 2608, a signal processor 2610, and a device-side interface 2612. The network-side interface 2602 may include any component or collection of components adapted to transmit or receive signaling over a wireless or wireline telecommunications network. The coupler 2604 may include any component or collection of components adapted to facilitate bi-directional communication over the network-side interface 2602. The transmitter 2606 may include any component or collection of components (e.g., up-converter, power amplifier, etc.) adapted to convert a baseband signal into a modulated carrier signal suitable for transmission over the network-side interface 2602. The receiver 2608 may include any component or collection of components (e.g., down-converter, low noise amplifier, etc.) adapted to convert a carrier signal received over the network-side interface 2602 into a baseband signal. The signal processor 2610 may include any component or collection of components adapted to convert a baseband signal into a data signal suitable for communication over the device-side interface(s) 2612, or vice-versa. The device-side interface(s) 2612 may include any component or collection of components adapted to communicate data-signals between the signal processor 2610 and components within the host device (e.g., the processing system 2500, local area network (LAN) ports, etc.).

The transceiver 2600 may transmit and receive signaling over any type of communications medium. In some embodiments, the transceiver 2600 transmits and receives signaling over a wireless medium. For example, the transceiver 2600 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 2602 comprises one or more antenna/radiating elements. For example, the network-side interface 2602 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 2600 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

The following provides example proposals as described in the above embodiments:
Proposal 1: Support doubling the maximum number of orthogonal DM-RS ports for both 1 and 2 OFDM symbol(s) configurations and both Type-1 and Type-2 of DM-RS configurations.
Proposal 2: Consider doubling either time domain cyclic shifts or frequency domain combs to double the maximum number of orthogonal DM-RS ports for Type-1 configuration.
Proposal 3: Consider doubling frequency domain size 2 RE pairs carrying distinct DM-RS ports from 3 to 6 to double the maximum number of orthogonal DM-RS ports for Type-2 configuration.
Proposal 4: Support UE to operate under legacy mode, i.e., DM-RS port(s) configuration, indexing, mapping, and indicating.
Proposal 5: Support UE to operate under additional DM-RS ports mode to improve system MU-MIMO performance.
Proposal 6: Support scheduling MU-MIMO transmissions of UEs operating in different modes (e.g., legacy mode and additional DM-RS ports mode).
Proposal 7: Based on legacy designs of DM-RS ports combination, signaling indication and message mapping, make necessary modifications for additional orthogonal DM-RS ports as little as possible to minimize standard efforts.

According to one aspect of the present disclosure, a method is provided that includes: receiving, by a user equipment (UE), a downlink control information (DCI) message comprising an antenna port(s) bits field and a demodulation reference signal (DM-RS) port offset bit; obtaining, by the UE, a first DM-RS port number(s) from an antenna port table based on the antenna port(s) bits field; when the DM-RS port offset bit is a first value, determining, by the UE, a second DM-RS port number(s) by adding the first DM-RS port number(s) and a pre-configured number, and communicating, by the UE, DM-RSs using antenna port(s) corresponding to the second DM-RS port number(s).

Optionally, in any of the preceding aspects, the method may further include: when the DM-RS port offset bit is a second value, communicating, by the UE, DM-RSs using antenna port(s) corresponding to the first DM-RS port number(s).

Optionally, in any of the preceding aspects, the method may further include: determining, by the UE, a number of DM-RS code division multiplexing (CDM) group(s) without data base on the antenna port(s) bits field from the antenna port table.

Optionally, in any of the preceding aspects, the pre-configured number is 8.

Optionally, in any of the preceding aspects, the method may further include: obtaining, by the UE, a first number of DM-RS code division multiplexing (CDM) groups without data from the antenna port table based on the antenna port(s) bits field; determining, by the UE, a second number of DM-RS CDM groups without data, which is two times of the first number of DM-RS CDM groups without data; and communicating, by the UE, based on the second number of DM-RS CDM groups without data.

Optionally, in any of the preceding aspects, the method may further include: determining, by the UE, a first set of CDM group indexes corresponding, respectively, to the first number of DM-RS CDM groups without data; determining, by the UE, a second set of CDM group indexes by adding an offset and the first set of CDM group indexes; and combining, by the UE, the first set of CDM group indexes and the second set of CDM group indexes to obtain a third set of CDM group indexes, the third set of CDM group indexes corresponding, respectively, to the second number of DM-RS CDM groups without data.

Optionally, in any of the preceding aspects, the method may further include: obtaining, by the UE, a first number of DM-RS code division multiplexing (CDM) groups without data from the antenna port table based on the antenna port(s) bits field; when the DM-RS port offset bit is the first value, obtaining, by the UE from the antenna table based on the antenna port(s) bits field, a first set of CDM group indexes; and determining, by the UE, a second set of CDM group indexes by adding an offset and the first set of CDM group indexes, the second set of CDM group indexes corresponding, respectively, to the first number of DM-RS CDM groups without data.

Optionally, in any of the preceding aspects, the offset is 2.

An apparatus is also provided for implementing the methods in any of the preceding aspects.

An advantage of embodiments of the present disclosure includes increased number of orthogonal DM-RS ports with relatively small DM-RS overhead. The embodiments allow for good demodulation performance, and enable to support a large number of data layers for massive SU/MU-MIMO transmissions.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a configuring unit/module, an activating unit/module, a table searching or lookup unit/module, a determining unit/module, a signaling unit/module, and/or an indicating unit/module. The respective units/modules may be hardware, software, or a combination thereof. For instance, one or more of the units/modules may be an integrated circuit, such as field programmable gate arrays (FPGAs) or application-specific integrated circuits (ASICs).

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

The following provides acronyms that may be used in the present disclosure.

| Acronyms | Description |
|---|---|
| 3GPP | 3rd Generation Partnership Project |
| 5G | Fifth generation |
| BWP | Bandwidth part |
| CA | Carrier aggregation |
| CDM | Code division multiplexing |
| CP | Cyclic prefix |
| CP-OFDM | Cyclic prefix- Orthogonal Frequency-Division |
| | Multiplexing |
| CRB | Common resource block |
| CRI | CSI-RS resource indicator |
| CSI | Channel State Information |
| CSI-RS | CSI reference signal |
| CSI-IM | Channel state information-interference |
| | measurement |
| CQI | Channel quality indication |
| DC | Dual connectivity |
| DCI | Downlink control information |
| DFT | Digital Fourier Transform |
| DM-RS | UE-specific reference signal (also known as |
| | “demodulation reference signal”) |
| eNB | Enhanced Node B |
| E-UTRAN | Evolved Universal Terrestrial Radio Access |
| | Network (LTE access network) |
| EN-DC | E-UTRA-NR dual connectivity |
| FD | Full duplex |
| FDD | Frequency division duplex |
| FDMA | Frequency division multiple access |
| FR | Frequency range |
| FR1 | Frequency range 1 (below 6 GHz) |
| FR2 | Frequency range 2 (above 6 GHz) |
| gNB | g-node B (NR node B) |
| MAC | Medium access control |
| MAC CE | Medium access control control element |
| MIMO | Multiple input multiple output |
| MU-MIMO | Multi user-MIMO |
| SU-MIMO | Single user-MIMO |
| NR | New radio |
| NZP | Non zero power |
| OCC | Orthogonal cover code |
| OFDM | Orthogonal Frequency-Division Multiplexing |
| OFDMA | Orthogonal frequency division multiple access |
| OS | OFDM symbol |
| PDCCH | Physical downlink control channel |
| PDSCH | Physical downlink shared channel |
| PSS | Primary synchronization signal |
| PT-RS | Phase tracking reference signal |
| PUCCH | Physical uplink control channel |
| PUSCH | Physical uplink shared channel |
| QCL | Quasi co-location |
| RAN | Radio access network |
| RB | Resource block |
| RBG | Resource block group |
| RE | Resource element |
| RS | Reference signal |
| SCell | Secondary Cell |
| SC-FDMA | Single carrier-frequency division multiple |
| | access |
| SINR | Signal to interference plus noise ratio |
| S-RSRP | Sidelink reference signal received power |
| SSB | Synchronization signal/PBCH block |
| TDD | Time division duplex |
| TDMA | Time division multiple access |
| TDRA | Time domain resource allocation |
| TPMI | Transmit precoding matrix indicator |
| TRP | Transmit/Receive Point |
| TRS | Tracking reference signal |
| UCI | Uplink control information |
| UDM | Unified data management |
| ZP | Zero power |

1. A user equipment (UE) comprising:
at least one processor; and
a non-transitory computer readable storage medium storing programming, the programming including instructions that, when executed by the at least one processor, cause the UE to perform operations including:
receiving, from a base station, a configuration indicating a first orthogonal cover code (OCC) length that is 4 and a second OCC length that is 2 for demodulation reference signal (DM-RS) communications between the base station and the UE;
receiving a signaling indicating the UE to communicate DM-RS(s) according to the first OCC length or the second OCC length; and
communicating, with the base station, a DM-RS according to the first OCC length or the second OCC length indicated by the signaling.

2. The UE of claim 1, wherein the receiving the configuration comprises:
receiving the configuration in a radio resource control (RRC) signaling.

3. The UE of claim 1, wherein the signaling is a RRC signaling.

4. The UE of claim 1, wherein the communicating the DM-RS comprises:
receiving or sending the DM-RS over first DM-RS port(s) associated with first OCC(s) of the first OCC length when the first OCC length is indicated by the signaling, or over second DM-RS port(s) associated with second OCC(s) of the second OCC length when the second OCC length is indicated by the signaling.

5. The UE of claim 4, the operations further comprising:
receiving a physical downlink shared channel (PDSCH) over the first DM-RS port(s) associated with the first OCC(s) of the first OCC length or over the second DM-RS port(s) associated with the second OCC(s) of the second OCC length; or
transmitting a physical uplink shared channel (PUSCH) over the first DM-RS port(s) associated with the first OCC(s) of the first OCC length or over the second DM-RS port(s) associated with the second OCC(s) of the second OCC length.

6. The UE of claim 1, wherein an OCC of the first OCC length comprises:
[+1+1+1+1], [+1−1+1−1], [+1+j−1−j], or [+1−j−1+j].

7. The UE of claim 1, the operations further comprising:
receiving a DCI message comprising an indication; and
receiving a DM-RS port offset bit, the indication and the DM-RS port offset bit in combination indicating information of DM-RS port(s) to be used by the UE.

8. The UE of claim 7, the operations further comprising:
when the first OCC length is indicated by the signaling and the DM-RS port offset bit is a first value, determining that the DM-RS port(s) to be used have first port number(s) according to a first correspondence between the first port number(s) and the indication, the first correspondence associated with the second OCC length; or
when the first OCC length is indicated by the signaling and the DM-RS port offset bit is a second value, determining that the DM-RS port(s) to be used have second port number(s) according to a second correspondence between the second port number(s) and the indication, the second correspondence associated with the first OCC length.

9. The UE of claim 1, wherein a number of DM-RS ports associated with the first OCC length of 4 is:
8 when one symbol is configured for type-1 DM-RS transmissions,
16 when 2 symbols are configured for type-1 DM-RS transmissions,
12 when one symbol is configured for type-2 DM-RS transmissions, or
24 when two symbols are configured for type-2 DM-RS transmissions.

10. A base station comprising:
at least one processor; and
a non-transitory computer readable storage medium storing programming, the programming including instructions that, when executed by the at least one processor, cause the base station to perform operations including:
sending, to a user equipment (UE), a configuration indicting a first orthogonal cover code (OCC) length that is 4 and a second OCC length that is 2 for demodulation reference signal (DM-RS) communications between the base station and the UE;
sending a signaling indicating the UE to communicate DM-RS(s) according to the first OCC length or the second OCC length; and
communicating, with the UE, a DM-RS according to the first OCC length or the second OCC length indicated by the signaling.

11. The base station of claim 10, wherein the sending the configuration comprises:
sending the configuration in a radio resource control (RRC) signaling.

12. The base station of claim 10, wherein the signaling is a RRC signaling.

13. The base station of claim 10, wherein the communicating the DM-RS comprises:
receiving or sending the DM-RS over first DM-RS port(s) associated with first OCC(s) of the first OCC length when the first OCC length is indicated by the signaling, or over second DM-RS port(s) associated with second OCC(s) of the second OCC length when the second OCC length is indicated by the signaling.

14. The base station of claim 13, the operations further comprising:
sending a physical downlink shared channel (PDSCH) over the first DM-RS port(s) associated with the first OCC(s) of the first OCC length or over the second DM-RS port(s) associated with the second OCC(s) of the second OCC length; or
receiving a physical uplink shared channel (PUSCH) over the first DM-RS port(s) associated with the first OCC(s) of the first OCC length or over the second DM-RS port(s) associated with the second OCC(s) of the second OCC length.

15. The base station of claim 10, wherein an OCC of the first OCC length comprises:
[+1+1+1+1], [+1−1+1−1], [+1+j−1−j], or [+1−j−1+j].

16. The base station of claim 10, the operations further comprising:
sending a DCI message comprising an indication; and
sending a DM-RS port offset bit, the indication and the DM-RS port offset bit in combination indicating DM-RS port(s) to be used.

17. The base station of claim 16, wherein:
when the first OCC length is indicated by the signaling and the DM-RS port offset bit is a first value, the DM-RS port(s) to be used have first port number(s) according to a first correspondence between the first port number(s) and the indication, the first correspondence associated with the second OCC length; or
when the first OCC length is indicated by the signaling and the DM-RS port offset bit is a second value, the DM-RS port(s) to be used have second port number(s) according to a second correspondence between the second port number(s) and the indication, the second correspondence associated with the first OCC length.

18. The base station of claim 10, wherein a number of DM-RS ports associated with the first OCC length of 4 is:
8 when one symbol is configured for type-1 DM-RS transmissions,
16 when 2 symbols are configured for type-1 DM-RS transmissions,
12 when one symbol is configured for type-2 DM-RS transmissions, or
24 when two symbols are configured for type-2 DM-RS transmissions.

19. A communication device comprising:
at least one processor; and
a non-transitory computer readable storage medium storing programming, the programming including instructions that, when executed by the at least one processor, cause the communication device to perform operations including:
transmitting a first demodulation reference signal (DM-RS) over first DM-RS port(s) associated with a orthogonal cover code (OCC) of length 4; or
receiving a second DM-RS over second DM-RS port(s) associated with an OCC of length 4.

20. The communication device of claim 19, wherein the communication device is a user equipment (UE) or a gNB.

21. The communication device of claim 19, wherein the OCC comprises:
[+1+1+1+1], [+1−1+1−1], [+1+j−1−j], or [+1−j−1+j].
